(19) United States
(12) Patent Application Publication
(10) Pub. No.: US 2012/0030094 A1
(43) Pub. Date: Feb. 2, 2012

(54) DESIGN, DEPLOYMENT, AND USE OF AN AUTOMATED FLOW-MODEL-VIEW-CONTROLLER WORKFLOW

(75) Inventor: Manah M. KHALIL, Irving, TX (US)

(73) Assignee: VERIZON PATENT AND LICENSING INC., Basking Ridge, NJ (US)

(21) Appl. No.: 12/843,937

(22) Filed: Jul. 27, 2010

(51) Int. Cl. G06Q 40/00

(52) U.S. Cl. 705/39

(57) ABSTRACT

A system includes a storage device to store design elements for a workflow design that, when deployed to a network, create a workflow that permits products or services to be purchased via an electronic transaction with a user device. The design elements correspond to a group of stages that process the electronic transaction or to workflow logic that establishes conditions to transfer the electronic transaction between the stages. Each stage includes business logic, separate from the workflow logic, that permits changes to be made to a stage in a manner that does not interrupt the workflow operation. The system also includes a server device to receive a request to deploy the workflow design; deploy the design elements to create the workflow; and conduct the electronic transaction by transferring the electronic transaction between an initiation stage and another stage based on workflow logic associated with the initiation stage and information regarding operations performed by the initiation stage.

### BACKGROUND

Electronic transactions systems have proliferated in recent years and now account for a significant portion of all transactions, such as sales transactions, banking transactions, business transactions, reservation transactions, etc. With respect to electronic sales transactions, for example, users, of user devices, may electronically purchase products and services by accessing an electronic transaction system, such as a customer-facing website on the Internet, by placing a call to a call center to receive assistance from a customer service agent, by placing a call to a voice portal that receives voice or keypad commands via the user device, etc.

Electronic sales transaction systems usually include a business application that manages and executes the electronic sales transaction with the user device. The business application may generate a series of user interfaces for each step of the electronic sales transaction, via which information from the user device may be received and/or information associated with the electronic sales transaction may be presented. The business application may also include business logic (e.g., for each step of the electronic sales transaction) that processes information received, via a user interface, from the user device and/or associated with the electronic sales transaction. The business application may further include a workflow that governs the transition between each step of the transaction. When changes are made to business processes, associated with the electronic sales transaction, the changes are usually made by updating or replacing the user interfaces, changing and/or upgrading the business logic, and/or revising the workflow. Implementing the changes to the user interfaces, the business logic, and/or the workflow, however, may require recoding or replacing the business application, which may cause a service disruption and/or may reduce sales during the disruption.

### BRIEF DESCRIPTION OF THE DRAWINGS

FIG. 1 is a diagram that illustrates an overview of an automated flow-model-view-controller workflow implementation described herein;

FIG. 2 is a diagram of an example network in which systems and/or methods described herein may be implemented;

FIG. 3 is a diagram of example components of one or more of the devices of FIG. 2;

FIG. 4A is a diagram of example functional components associated with an automated flow-model-view-controller work flow;

FIG. 4B is a diagram of an example workflow design user interface;

FIG. 5 is a flowchart of an example process for using an automated flow-model-view-controller workflow;

FIG. 6 is a flow diagram of an example flow-model-view-controller workflow design for an automated electronic transaction;

FIG. 7 is an example session metrics memory;

FIG. 8 is a flowchart of an example process for obtaining session metrics or flow-model-view-controller workflow metrics;

FIG. 9A is diagram of an example electronic transaction record; and

FIG. 9B is a diagram of example flow-model-view-controller workflow metrics.

### DETAILED DESCRIPTION OF PREFERRED EMBODIMENTS

The following detailed description refers to the accompanying drawings. The same reference numbers in different drawings may identify the same or similar elements. Also, the following detailed description does not limit the invention.

An implementation, described herein, may include systems and/or methods that provide for the design, deployment, and/or use an automated flow-model-view-controller workflow that enables automated electronic transactions (hereinafter referred to as “electronic transactions”), across multiple electronic transaction channels (e.g., via mobile telephone networks, the Internet, television networks, social networking sites, email, etc.).

As described herein, an automated flow-model-view-controller (FMVC) workflow may be designed, may be deployed to a network, and/or may be used in accordance with an FMVC framework. Additionally, or alternatively, an FMVC application may enable a workflow designer to design an FMVC workflow, may permit an FMVC workflow design to be automatically deployed to a network, and/or may enable a user, of a user device, to use the deployed FMVC workflow to conduct an electronic transaction session (hereinafter referred to as a “session”). The term “FMVC workflow,” as used herein may include a set of stages that perform operations (e.g., based on business logic) associated with a session and paths via which the session may be transitioned between stages (e.g., based on FMVC workflow logic), in order to perform an electronic transaction.

In one example implementation, the FMVC framework may include a flow, a model, a view, a controller, and/or other framework elements. The term “flow,” as used herein generally refers to FMVC workflow logic that includes a set of rules (e.g., workflow rules) that are used by the FMVC application to determine whether to and/or under what conditions a session is to be transferred between stages of the FMVC workflow. The term “model,” as used herein, generally refers to a business application that performs operations associated with a stage within the FMVC workflow, with which the business application is associated. The term “view,” as used herein generally refers to a user interface (UI), or set of UIs, associated with a stage or set of stages within the FMVC workflow, via which information may be presented to and/or received from a user of a user device. The term “controller,” as used herein, may generally refer to a device that renders the UI or set of UIs associated with the stage or set of stages within the FMVC workflow. Additionally or alternatively, a controller may receive information from the user device, via a UI, and may translate the received information into a data format and/or data structure (hereinafter referred to as a “business entity”) that the business application can receive and/or process using business logic. Additionally, or alternatively, the controller may receive and instruction and/or information (e.g., as a business entity) from the business application and may send the received instruction and/or information, via the UI, in a format that can be received and/or processed by the user device.

As further described herein, the FMVC framework may employ a modular architecture that separates controllers, that render the UIs, from business applications that process information (e.g., using business logic) corresponding to each stage of the FMVC workflow. Separating the UIs from the business application may, for example, permit introduction, revision, and/or replacement of UIs and/or business applications/logic associated with existing and/or new electronic transaction channels without causing a disruption of an electronic transaction service.

As yet further described herein, the modular architecture of the FMVC framework may separate the FMVC workflow logic from the business application and/or business logic. The separation of the FMVC workflow from the business application may, for example, permit business applications, associated with one or more sales and marketing channels, to be introduced, revised, or replaced without causing a disruption of an electronic transaction service.

In another example implementation, the FMVC application may include an FMVC workflow designer that permits an FMVC workflow, associated with an electronic transaction, to be designed and/or deployed to a network. More particularly, the FMVC workflow designer may, for example, include a collection of design elements that permit each stage of the FMVC workflow to be defined (e.g., based on business logic, type of stage, etc.) and/or the workflow rules and/or conditions associated with entering, exiting, and/or transitioning between each stage to be defined. In another example, the FMVC workflow designer may permit a workflow designer and/or network administrator to automatically deploy the FMVC workflow to a network.

In yet another example implementation, the FMVC application may permit a session, with a user device, to be automatically conducted using a deployed FMVC workflow. Additionally, or alternatively, the FMVC application may enable metrics, associated with a session and/or set of sessions to be collected, stored, and/or analyzed in order to assess whether business objectives are being achieved, to optimize the FMVC workflow, and/or to revise and/or replace workflow logic, business logic, and/or UIs associated with the FMVC workflow.

The FMVC workflow is described herein as being associated with an electronic sales transaction for explanatory purposes. In practice, the FMVC workflow may be associated with automated electronic transactions other than the electronic sales transaction, such as an automated electronic business transaction, an automated electronic banking transaction, an automated electronic reservations transaction, etc.

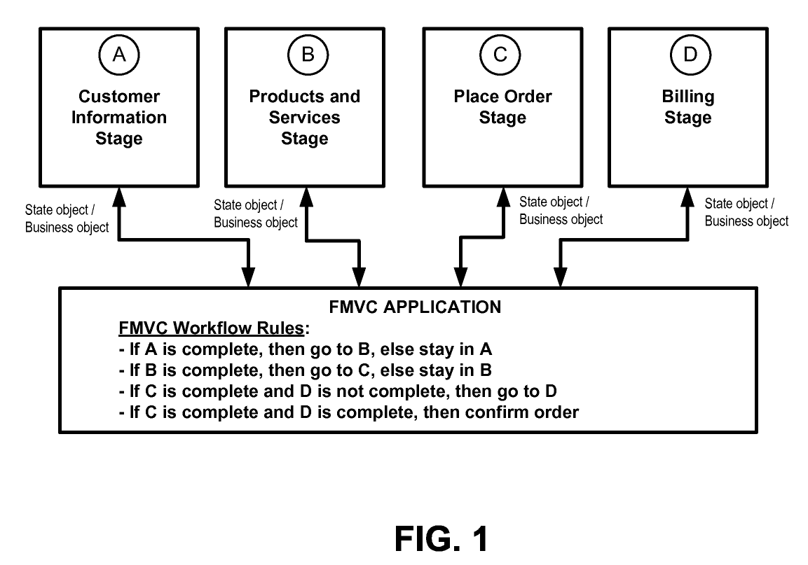

FIG. 1 is a diagram that illustrates an overview of an FMVC workflow implementation described herein. As illustrated in FIG. 1, for example, an FMVC application may control an FMVC workflow using a collection of stages that were designed and/or deployed, to a network, by the FMVC application. The FMVC workflow may include a customer information stage (shown as indication A), a products and services stage (shown as indication B), a place order stage (shown as indication C), a billing stage (shown as indication D), and/or an FMVC application. While FIG. 1 illustrates an FMVC workflow that includes certain stages, such as stages A-D, in another implementation, an FMVC workflow may include fewer stages, additional stages, different stages, or differently arranged stages than are described with respect to FIG. 1.

The FMVC application may be used to design an FMVC workflow. For example, and as further described below, the FMVC application may permit stages to be defined in which each stage includes a business application that includes business logic that performs operations associated with a particular stage (e.g., processing user information, determining a credit history, processing orders for products or services, checking inventory, processing payment information, etc.). Additionally, or alternatively, each stage may optionally include a controller that renders a UI via which information, associated with the particular stage, may be presented to and/or received from a user device. In another example, the FMVC application may permit workflow rules to be established that include conditions to be satisfied (e.g., when the FMVC application evaluates the condition “to be true”) in order to enter a stage, to exit a stage, and/or to permit a session to be transferred.

The FMVC application may permit a protected stage to be defined. For example, as described above, each stage, including a protected stage, includes a business application (e.g., a model) that executes business logic in order to perform an operation associated with a session. The protected stage may optionally include a controller that renders a UI via which information, associated with the particular stage, may be presented to and/or received from a user device.

A protected stage may be entered from a particular stage, as defined by the workflow rules (e.g., workflow logic). For example, the FMVC application may not transfer a session to a protected stage from another stage that is not defined as a predecessor stage in the workflow rules associated with the protected stage. More particularly, the FMVC application may receive a business object and/or a state object from a business application associated with a stage. The business object may include, for example, information generated by the business application based on a business entity received from a controller. Additionally, or alternatively, the state object may, for example, include information associated with the session state that indicates the current stage associated with the session and/or a next stage. The FMVC application may identify the next stage from the state object and may determine whether the next stage is a protected stage. If the next stage is a protected stage, then the FMVC application may, for example, determine whether the information contained in the business object satisfies conditions identified in a workflow rule that transfers the session from the previous stage to the next stage (e.g., the protected stage).

The FMVC application may permit a UI-less stage to be defined. For example, a UI-less stage may include a business application, but may not include a UI and/or a controller to render the UI via which information may be received from and/or present to a user device. The business application in a UI-less stage may, for example, perform operations on information received and/or sent via another stage and/or via the FMVC application, but not via a UI.

The FMVC application may permit a conditionally UI-less stage to be defined. For example, a stage may be UI-less depending on whether a condition associated with an inbound session has been met. In one example, if a condition, associated with a session, has been satisfied (e.g., billing information is on file and/or stored in a data base), then a UI to obtain billing information from a user may not be rendered. In another example, if a condition, associated with another session, has not been satisfied (e.g., billing information is not on-file), then the business application may send an instruction to a controller to render a UI via which the billing information may be received from a user.

Still other stages may be defined with respect to a location within the FMVC workflow, such as a workflow initiation stage (e.g., that initiates a session with a user device), a terminal stage (e.g., that concludes a session), and/or an intermediate stage (e.g., that is neither an initiation nor a terminal stage).

Customer information stage (indication A) may permit a user, of a user device, to initiate a session by entering information (e.g., associated with the user) into a UI rendered by a controller associated with the customer information stage. The controller may receive, via the UI, the information associated with the user and may translate the information into a business entity to be received and/or processed by a business application associated with the customer information stage. The business application may perform an operation using the business entity (e.g., to determine whether the user is a new or existing customer, to confirm user address information, etc.) and may generate a business object as a result of the operation. The business object may, for example, contain indicators regarding whether the user is a new or existing customer, etc. The business application may send the business object and a state object to the FMVC application. The state object may include information associated with a session state that may include a current stage identifier (e.g., customer information stage) and/or a next stage identifier (e.g., products and services stage).

The FMVC application may receive the business object and/or the state object and may retrieve workflow rules that govern whether and/or the manner in which the session is to be transferred to a next stage. For example, the FMVC application may determine, based on the workflow rules and/or the state object, that the next stage is a protected stage. Based on the determination, the FMVC application may, for example, determine whether indicators included in the business object satisfy the conditions specified in the workflow rules (e.g., whether conditions evaluate to be true). In this example, the FMVC may determine that the indicators in the business object satisfy conditions associated with a workflow rule that enables the transfer of the session to the next stage (e.g., a products and services stage).

Products and services stage (indication B) may be an intermediate stage that may permit the user to review, via a catalog UI rendered by a controller associated with the products and services stage, a variety of products or services and/or to indicate that the user desires to make a purchase. The controller may receive the indication via the catalog UI and may forward, as a business entity, the indication to a business application associated with the products and services stage. The business application may perform an operation based on the indication (e.g., identifying similar products and services based on the user browsing patterns, etc.) and may generate a business object to be forwarded, together with a state object, to the FMVC application.

The FMVC application may receive the business object and/or the state object and may retrieve workflow rules associated with the current stage. Based on the workflow rules, the FMVC application may, for example, determine that the next stage is not a protected stage and may automatically transfer the session to the next stage (e.g., place order stage).

Place order stage (indication C) may permit the user to select particular products or services, via an ordering UI rendered by a controller associated with the place order stage. The controller may receive, via the ordering UI, the selected products or services and may forward the selection, as a business entity, to a business application associated with the place order stage. The business application may perform an operation using the received selection (e.g., checking inventory, determining availability in the location of the user, etc.) and may generate a business object that may be forwarded the business object and/or a state object to the FMVC application.

The FMVC application may receive the business object and/or the state object and may, in the manner described above, retrieve workflow rules associated with the current state (e.g., place order stage). The FMVC application may determine whether indicators included in the business object satisfy the conditions specified in the workflow rules (e.g., whether conditions evaluate to be true). In this example, the FMVC may determine that the indicators in the business object satisfy conditions associated with a workflow rule that transfers the session to the next stage (e.g., a billing stage).

Billing stage (indication D) may be a terminal stage that permits the user to enter billing information (e.g., credit card information, billing address, etc.), via a payment UI rendered by a controller associated with the billing stage. The controller may receive the billing information, via the payment UI, and may forward the billing information, as a business entity, to a business application associated with the billing stage. The business application may perform an operation using the business entity (e.g., verify credit card information, billing address, obtain credit history, etc.) and may generate a business object as a result of the operation. The business application may forward the business object and/or a state object to the FMVC application.

The FMVC application may receive the business object and/or the state object and may retrieve workflow rules associated with the current state (e.g., billing stage). From the workflow rules, the FMVC may determine that the current stage is a terminal stage and the session may end if the conditions associated with the terminal stage are satisfied. For example, the FMVC application may determine that indicators included in the business object satisfy the conditions specified in the workflow rules (e.g., whether conditions evaluate to be true). In this example, the FMVC may determine that the indicators in the business object satisfy conditions associated with a workflow rule that ends the session.

By separating the workflow rules from the business logic, the UIs, or the controller logic, changes may be made to the FMVC workflow that do not cause a disruption to the FMVC workflow. For example, changes may be made to the business logic, the UIs, and/or the controller logic, associated with all or a portion of the stages of an FMVC workflow, in a manner that is independent of the FMVC application and/or that does not cause a disruption to the FMVC workflow. Additionally, or alternatively, the FMVC application may permit a FMVC workflow designer and/or a network administrator to obtain metrics (e.g., associated with a deployed FMVC workflow) that may permit performance monitoring and/or changes to the FMVC workflow to improve performance.

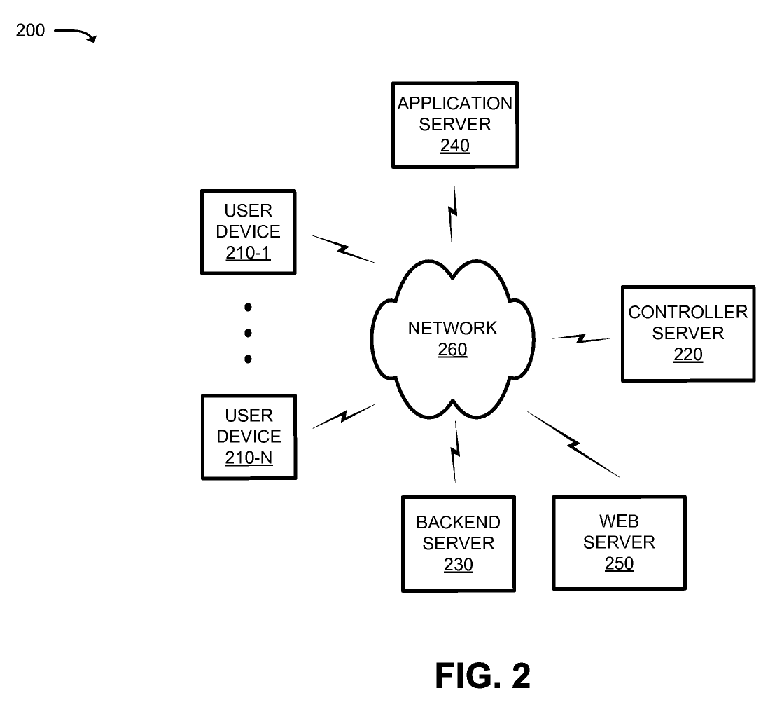

FIG. 2 is a diagram of an example network 200 in which systems and/or methods described herein may be implemented. As shown in FIG. 2, network 200 may include a set of user devices 210-1, . . . , 210-N (where N≧1) (hereinafter referred to collectively as “user devices 210” and individually as “user device 210”), a controller server 220, a backend server 230, an application server 240, a web server 250, and a network 260. The number of devices, illustrated in FIG. 2, is provided for explanatory purposes only. In practice, there may be additional devices, fewer devices, different devices, or differently arranged devices than illustrated in FIG. 2.

Also, in some implementations, one or more of the devices of network 200 may perform one or more functions described as being performed by another one or more of the devices of network 200. For example, controller server 220, backend server 230, and/or application server 240 may be integrated into a single device. Devices of network 200 may interconnect via wired connections, wireless connections, or a combination of wired and wireless connections.

User device 210 may include any computation or communication device, such as a wireless mobile communication device that is capable of communicating via network 260. For example, user device 210 may include a radiotelephone, a personal communications system (PCS) terminal (e.g., that may combine a cellular radiotelephone with data processing and data communications capabilities), a personal digital assistant (PDA) (e.g., that can include a radiotelephone, a pager, Internet/intranet access, etc.), a laptop computer, a personal computer, a landline telephone, a set top box (STB), a television, a camera, a personal gaming system, or another type of computation or communication device.

User device 210 may be associated with unique identification information that enables controller server 220, backend server 230, application server 240, and/or other network devices to distinguish user device 210 from other user devices 210. The user device identification information may include, for example, a private identifier (e.g., an international mobile subscriber identity (IMSI), a national access identifier (NAI), etc.), a public identifier (e.g., a mobile device number (MDN), a landline device number (LDN), a mobile subscriber integrated services digital network (MSISDN), etc.), an Internet protocol (IP) address, etc.

Controller server 220 may include one or more server devices, or other types of computation or communication devices, that gather, process, search, store, and/or provide information in a manner similar to that described herein. For example, controller server 220 may host a UI controller, or set of UI controller(s) (hereinafter referred to collectively as “controllers” or individually as a “controller”) that correspond to a stage, or set of stages, that are associated with an FMVC workflow. For example, a controller may present a UI for display on user device 210 via which information, associated with the particular stage, may be presented to a user of user device 210 and/or received from user device 210. More particularly, the controller may communicate with user device 210, and may render a UI on user device 210 based on the type of user device 210 via which the controller is communicating (e.g., a cellular telephone, a laptop computer, a PDA, etc.). In another example, if the controller determines that user device 210 is a landline telephone, then the controller may render a voice portal via which communication with user device 210 may be conducted.

The controller may receive information from user device 210, via a UI, associated with a particular stage of an FMVC workflow, and may forward the received information to a business application, hosted by controller server 220, application server 240 and/or some other network device (e.g., backend server 230), to be processed. In another example, the controller may process the received information to convert the received information into a data format or structure that may be received by the business application (e.g., as a business entity). In yet another example, controller may receive a business entity from a business application and may convert the business entity into a data format that may be received and/or processes, via a UI, by user device 210.

Backend server 230 may include one or more server devices, or other types of computation or communication devices, that gather, process, search, store, and/or provide information in a manner similar to that described herein. For example, backend server 230 may include a server device that provides services associated with an FMVC workflow. More particularly, backend server 230 may communicate with a controller (e.g., hosted by controller server 220), a business application (e.g., hosted by controller server 220 and/or application server 240), and/or a FMVC application (e.g., hosted by application server 240) to provide services associated with a session, such as providing email services (e.g., sending/receiving emails to/from user device 210), providing authentication services, scheduling service calls, validating billing information, collecting and/or storing metrics associated with the session, and/or providing other services.

Application server 240 may include one or more server devices, or other types of computation or communication devices, that gather, process, search, store, and/or provide information in a manner similar to that described herein. For example, application server 240 may include a server device that hosts a FMVC application that manages and/or controls, based on workflow rules, the transition of a session between stages of the FMVC workflow. For example, the FMVC application may receive a business object and/or a state object, associated with a particular session, from a business application corresponding to a particular stage. The FMVC application may use the state object to retrieve workflow rules associated with the current stage and a next stage to which the session may be transferred. The FMVC may determine whether information included in the business object satisfies conditions included in the workflow rules and may transfer the session to the next stage based on a determination that the conditions area satisfied (e.g., whether conditions evaluate to be true).

The FMVC application may store metrics associated with a session. For example, the FMVC application may store metrics regarding a session associated with user device 210. The metrics may be received from a stage, or set of stages, via which the session has been transferred, and may include user device 210 identification information, information associated with a user of user device 210, billing information, products or services viewed by the user, particular products or services the user has selected (e.g., placed in a virtual cart to be purchased), the stages and/or UIs associated with the session, and/or other information associated with the session (e.g., a session identifier, a session start time, a session conclusion time, times associated with stage entry and/or exit entry, purchase amounts, a service date, etc.). The FMVC application may store the metrics in a memory associated with application server 240.

Web server 250 may include one or more server devices, or other types of computation or communication devices, that gather, process, search, store, and/or provide information in a manner similar to that described herein. For example, web server 250 may include a server device that hosts a website or an application, and/or permits access to services that may be used by an FMVC workflow. In one example, a business application (e.g., hosted by controller server 220 or application server 240), associated with a particular stage of the FMVC workflow, may communicate with web server 250 to determine the creditworthiness of a user of user device 210 associated with a session. Web server 250 may perform an operation to determine the creditworthiness of the user, based on information associated with the user (e.g., a social security number and/or other information) obtained from the communication with the business application and may send information associated with the creditworthiness of the user to the business application. In another example, another business application (e.g., hosted by controller server 220 or application server 240), associated with another stage of the FMVC workflow, may communicate with web server 250 to verify billing information and/or to process a payment for products or services selected by the user for purchase during a session with user device 210.

Network 260 may include one or more wired and/or wireless networks. For example, network 260 may include a cellular network, the Public Land Mobile Network (PLMN), a 2G network, a 3G network, and/or a 4G network. Additionally, or alternatively, network 260 may include a wide area network (WAN), a metropolitan area network (MAN), a telephone network (e.g., the Public Switched Telephone Network (PSTN)), an ad hoc network, an intranet, the Internet, a fiber optic-based network (e.g., a fiber optic service (FiOS) network), and/or a combination of these or other types of networks.

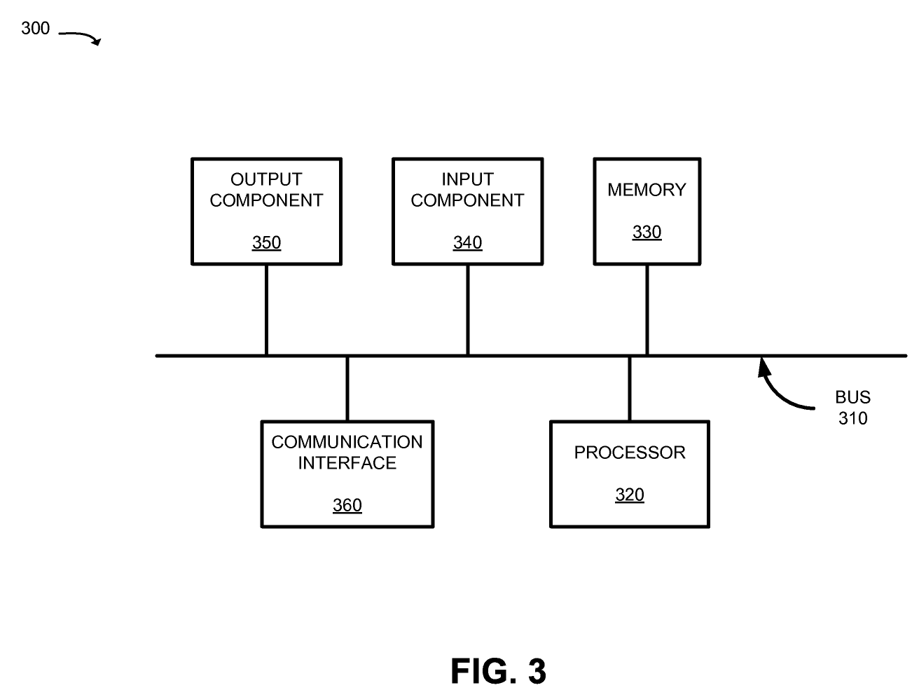

FIG. 3 is a diagram of example components of a device 300. Device 300 may correspond to user device 110, controller server 220, backend server 230, application server 240, and/or web server 250. Device 300 may include a bus 310, a processor 320, a memory 330, an input component 340, an output component 350, and a communication interface 360. Although FIG. 3 shows example components of device 300, in other implementations, device 300 may contain fewer components, additional components, different components, or differently arranged components than depicted in FIG. 3. For example, device 300 may include one or more switch fabrics instead of, or in addition to, bus 310. Additionally, or alternatively, one or more components of device 300 may perform one or more tasks described as being performed by one or more other components of device 300.

Bus 310 may include a path that permits communication among the components of device 300. Processor 320 may include a processor, microprocessor, or processing logic that may interpret and execute instructions. Memory 330 may include any type of dynamic storage device that may store information and instructions, for execution by processor 320, and/or any type of non-volatile storage device that may store information for use by processor 320.

Input component 340 may include a mechanism that permits a user to input information to device 300, such as a keyboard, a keypad, a button, a switch, etc. Output component 350 may include a mechanism that outputs information to the user, such as a display, a speaker, one or more light emitting diodes (LEDs), etc. Communication interface 360 may include any transceiver-like mechanism that enables device 300 to communicate with other devices and/or systems via wireless communications (e.g., radio frequency, infrared, and/or visual optics, etc.), wired communications (e.g., conductive wire, twisted pair cable, coaxial cable, transmission line, fiber optic cable, and/or waveguide, etc.), or a combination of wireless and wired communications. For example, communication interface 360 may include mechanisms for communicating with another device or system via a network, such as network 260. In one alternative implementation, communication interface 360 may be a logical component that includes input and output ports, input and output systems, and/or other input and output components that facilitate the transmission of data to other devices.

As will be described in detail below, device 300 may perform certain operations relating to a design, deployment, and/or use of a FMVC workflow. Device 300 may perform these operations in response to processor 320 executing software instructions contained in a computer-readable medium, such as memory 330. A computer-readable medium may be defined as a physical or logical memory device. A logical memory device may include memory space within a single physical memory device or spread across multiple physical memory devices. The software instructions may be read into memory 330 from another computer-readable medium or from another device. The software instructions contained in memory 330 may cause processor 320 to perform processes described herein. Alternatively, hardwired circuitry may be used in place of or in combination with software instructions to implement processes described herein. Thus, implementations described herein are not limited to any specific combination of hardware circuitry and software.

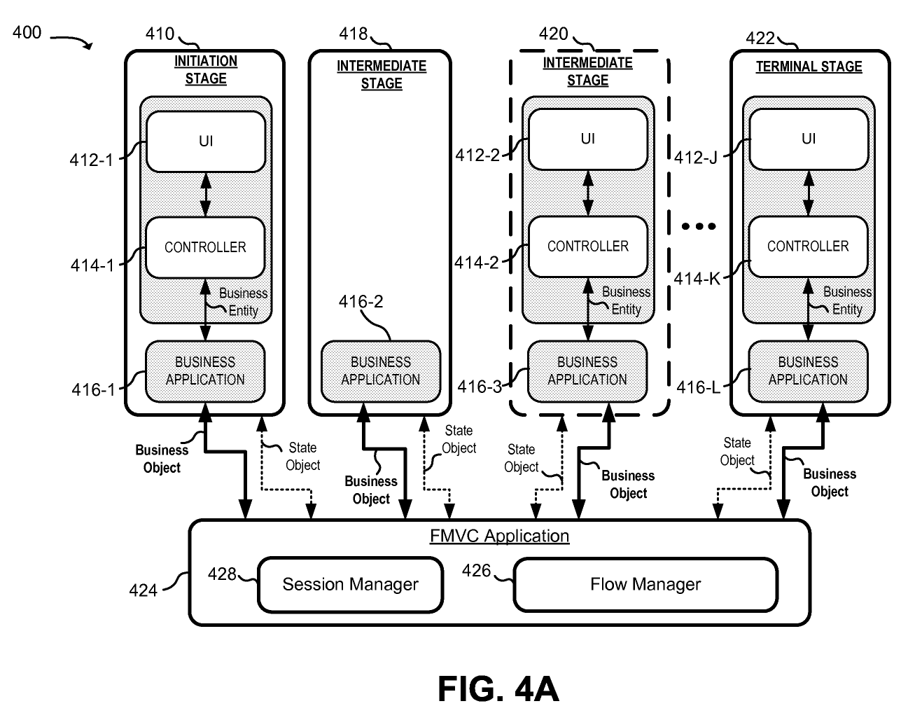

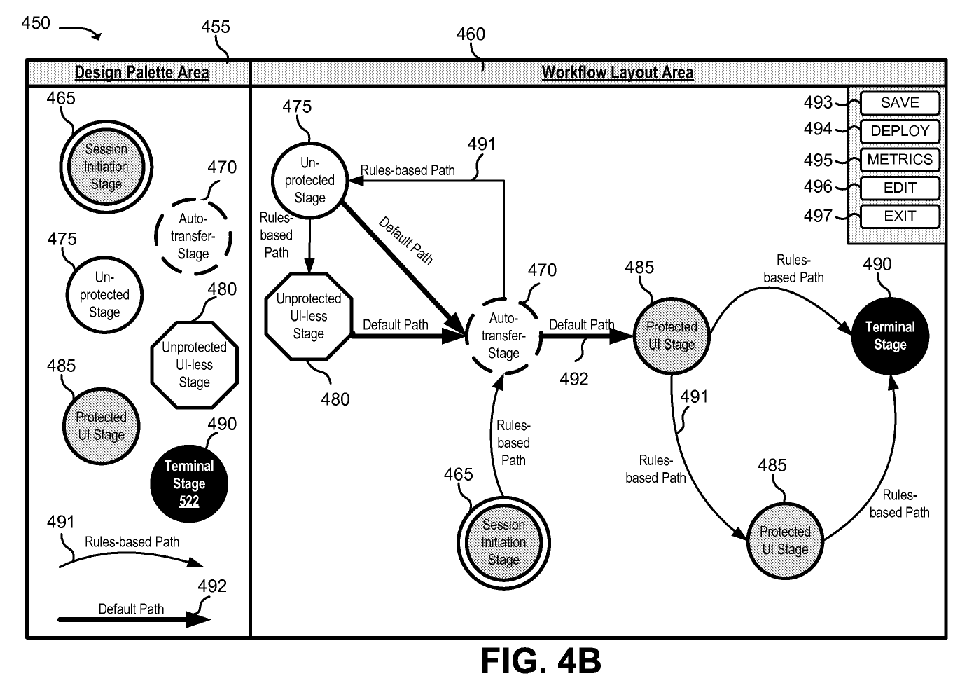

FIG. 4A is a diagram of example functional components associated with an FMVC workflow 400. In one example, FMVC workflow 400 may be implemented by one or more devices of network 200 (FIG. 2). As shown in FIG. 4A, FMVC workflow 400 may include a collection of functional components, such as an initiation stage 410, user interfaces (e.g., UI) 412-1, . . . 412-J (where J≧1), controllers 414-1, . . . 414-K (where K≧1), business applications 416-1, . . . , 416-L (where L≧1), intermediate stages 418 and 420, a terminal stage 422, a FMVC application 424, a flow manager 426, and/or a session manager 428.

Although FIG. 4A shows functional components of FMVC workflow 400, in other implementations, FMVC workflow 400 may include fewer functional components, additional functional components, different functional components, or differently arranged functional components than depicted in FIG. 4A. Additionally, or alternatively, one or more functional components of FMVC workflow 400 may perform one or more tasks described as being performed by one or more other functional components of FMVC workflow 400.

Initiation stage 410 may be stage used to initiate a session to permit a user, of user device 210, to electronically purchase products or services using FMVC workflow 400. Initiation stage 410 may include UI 412-1, controller 414-1 and/or business application 416-1. UI 412-1 may include one or more UIs via which information may be received from user device 210 and/or presented to user device 210 for display. Controller 414-1 may render a UI or set of UIs (e.g., UI 412-1). For example, controller 414-1 may receive information, via UI 412-1, from user device 210 and/or may translate the received information into a format and/or data structure (e.g., a business entity) that may be received and/or processed by business application 416-1. Additionally, or alternatively, controller 414 may receive information (e.g., a business entity) from business application 416-1 and may translate the business entity into a channel-specific data format/structure that may permit the information to be presented, via UI 412-1, on user device 210.

Business application 416-1 may perform operations using a business entity received from controller 414-1 (e.g., processing user information, retrieving customer profile information, etc.) that are pertinent to initiation stage 410. For example, business application 416-1 may receive a business entity associated with user device 210 (e.g., an MDN, LDN, IP address, IMSI, MSISDN, etc.) and may process the business entity to determine whether a user, of user device 210, is a new customer or an existing customer. Additionally, or alternatively, business application 416-1 may generate information (e.g., a business object) as a result of operations performed on the business entity by business application 416-1. For example, business application 416-1 may generate a business object that includes an indication that information associated with user device 210 was received, that the received information was processed, and/or whether the user, of user device 210, is a new customer or a prior customer, etc. Business application 416-1 may send the business object and a state object to FMVC application 424. The state object may include information associated with a current stage (e.g., initiation stage 410).

Intermediate stage 418 may be a stage that is a UI-less stage (e.g., no UI layer is associated with intermediate stage 418 as shown in FIG. 4A) and may be used to perform certain operations associated with a session for user device 210. Intermediate stage 418 may include a business application (e.g., business application 416-2). Business application 416-2 may perform operations, associated with intermediate stage 418, that may not be presented to and/or accessible by user device 210. For example, business application 416-2 may obtain information associated with a customer profile corresponding to a user of user device 210 based on a determination that the user is an existing customer (e.g., as determined by initiation stage 410). Business application 416-2 may, in a manner similar to that described above, send a business object (e.g., that contains indicators associated with operations performed by business application 416-2) and/or a state object (e.g., that contains information associated with a current stage) to FMVC application 424.

Intermediate stage 420 may be a stage that is a conditional UI-less stage (e.g., shown by the dashed line associated with intermediate stage 420) that may be used to perform certain operations associated with a session for user device 210. Intermediate stage 430 may include UI 412-2, controller 414-2 and/or business application 416-3. UI 412, controller 414-2 and/or business application 416-3 may perform acts in a manner similar to that described above with respect to initiation stage 410. Additionally, or alternatively, business application 416-3 may obtain billing information corresponding to a user (e.g., of user device 210) associated with a session for the purchase of selected products or services. In one example, if business application 416-3 determines that the billing information associated with the user is not on file, then business application 416-3 may send a business entity to controller 414-2 which may cause a UI to be rendered (e.g., UI 412-2), on user device 210, to obtain billing information from the user. In another example, if business application 416-3 determines that billing information, associated with the user, is on file (e.g., is stored in a memory), then business application 416-3 may retrieve the billing information without causing controller 414-2 to render a UI, or set of UIs (e.g., UI 412-2). Business application 416-3 may, in a manner similar to that described above, send a business object (e.g., that contains indicators associated with operations performed by business application 416-3) and/or a state object (e.g., that contains information associated with a current stage) to FMVC application 424.

Terminal stage 422 may be a termination stage that may be used to conclude a session with user device 210. Terminal stage 422 may include UI 412-J, controller 414-K and/or business application 416-L. UI 412-J, controller 414-K and/or business application 416-L may perform acts in a manner similar to that described above with respect to initiation stage 410. Additionally, or alternatively, business application 416-L may perform operations that conclude the session with user device 210, such as generating confirmation information associated with a purchase of products or services, generating a receipt for the payment of the products or services. Business application 416-L may, in a manner similar to that described above, send a business object (e.g., that contains indicators associated with operations performed by business application 416-L) and/or a state object (e.g., that includes information associated with a current stage) to FMVC application 424.

FMVC application 424 may include flow manager 426 and/or session manager 428. Flow manager 426 may store workflow logic that may be used to manage and/or control the transition of a session between stages of FMVC workflow 400. For example, FMVC application 424 may receive a business object and/or a state object, associated with a particular session with user device 210, from a business application corresponding to a particular stage. FMVC application 424 may use the received state object to determine a current stage associated with the session and may retrieve, from flow manager 426, workflow rules associated with the current stage. FMVC application 424 may, for example, determine whether indicators included in the business object satisfy conditions associated with the workflow rules. In one example, based on a determination that the conditions are satisfied (e.g., the conditions are evaluated to be true), then FMVC application 424 may transfer the session from the current stage to a next stage in accordance with the workflow rules. In another example, based on a determination that the conditions are not satisfied (e.g., the conditions are evaluated to be false), then FMVC application 424 may not transfer the session from the current stage to a next stage. In yet another example, FMVC application 424 may determine, from the workflow rules, that the next stage is not a protected stage (e.g., may be entered from any stage and/or at any time) and may transfer the session to the unprotected stage.

For example, FMVC application 424 may receive the business object and/or state object from business application 416-1. The business object may, for example, include indicators that information, associated with user device 210, was received, that the received information was processed, and/or whether the user, of user device 210, is a new customer or an existing customer, etc. Flow manager 426 may, for example, retrieve workflow rules associated with a stage included in the state object (e.g., initiation stage 410) and may determine whether conditions, included in the workflow rules, associated with initiation stage 410, have been satisfied (e.g., whether the conditions evaluate to be true). In one example, if the conditions evaluate to be true, then the FMVC application 424 may transfer the session to intermediate stage 418. In another example, if the conditions evaluate to be false, then FMVC application 424 may not transfer the session. In yet another example, if the workflow rules indicate that the next stage is not a protected stage (e.g., intermediate stage 418), then FMVC application 424 may transfer the session to intermediate stage 418.

One example of an algorithm that may perform the acts, functions and/or operations described above is provided as follows:

```
Session_State
{
    Previous_Stage
    Current_Stage
    Start_Time
}
Bussiness_Entities
{
    Name
    IsDirty( )
    Serialize( )
    Deserialize( )
}
Business_Entity Derives From Bussiness_Entities
{
    Property_1
    Property_2
}
Controller.SubmitUIForm(Form_Content, Session_ID,
[Proposed_Next_Stage])
{
    Business_Entity = Controller.GetBusinessEntity(Form_Content)
    View.Error_Bag = Model.Validate(Business_Entity)
    If (View.Error_Bag.Count != 0)
    {
        View.Render(Session_ID, Error_Bag)
    }
    Else
    {
        SessionManager.AddBusinessEntity(Session_ID,
        Business_Entity)
        Model.ProcessBusinessEntity(Session_ID)
        View.Render(Session_ID)
    }
}
Model.ProcessBusinessEntity(Session_ID)
{
    ExecuteStageBusinessLogic(Session_ID)
    Session = SessionManager[Session_ID]
    Session.Session_State.Previous_Stage =
SessionManager.Session_State.Current_Stage
    Session.Session_State.Next_Stage =
GetWorkflowNextStage(Session_ID,
[Proposed_Next_Stage])
    If ( BusinessModel.IsUILess(Session.Current_Stage) OR
        (BusinessModel.IsConditionallyUILess(Session.Current_Stage)
AND BusinessModel.IsStageCompletionConditionsMet(Session)) )
    {
        ProcessBusinessEntity(Session_ID)
    }
    Else
    {
        Return
    }
}
WorkflowManager.GetWorkflowNextStage(Session_ID,
[Proposed_Next_Stage])
{
    If (Proposed_Next_Stage ! = null)
    {
        If (!IsStageProtected(Proposed_Next_Stage)
        {
            Next_Stage = Proposed_Next_Stage
        }
        Else
        {
            If (IsValidNextStage(Session_ID, Proposed_Next_Stage))
            {
                Next_Stage = Proposed_Next_Stage
            }
        }
    }
    Else
    {
        NextStage = GetNextStageBasedOnRules(Session_ID)
    }
    Return(Next_Stage)
}
Workflow.IsValidNextStage(Session_ID, Proposed_Next_Stage)
{
    Session_State = SessionManager.GetStateObject(Session_ID)
    Outbound_Paths = GetOutboundPaths(Session_State.CurrentStage)
    If (Outbound_Paths.HasPathToStage(Proposed_Next_Stage) AND
Outbound_Paths.IsRulesToStageTrue(Session_Stage.Current_Stage,
Proposed_Next_Stage))
    {
        Return True
    }
    Else
    {
        Return False
    }
}
```

Session manager 428 may perform session management operations. For example, FMVC application 424 may receive information regarding a session (e.g., associated with user device 210) from controllers 414 and/or business applications 416 associated with a stage, or set of stages, via which the session has been transferred and the received information may be stored, as session metrics, in session manager 428. The session metrics may include user device 210 identification information, customer profile information, information associated with a user of user device 210, billing information, products or services viewed by the user, particular products or services the customer has selected (e.g., placed in a virtual cart to be purchased), the stages and/or UIs associated with the session, and/or other information associated with the session (e.g., a session identifier, a session start time, a session conclusion time, times associated with stage entry and/or exit entry, purchase amounts, a service date, etc.). FMVC application 424 may store the session metrics in a memory associated with application server 240.

FIG. 4B is a diagram of example workflow design UI 450. In one example, workflow design UI 450 may be implemented by one or more devices of network 200 (FIG. 2). As illustrated in FIG. 4B, for example, FMVC application 424 (FIG. 4A) may present, on a display associated with application server 240, a workflow design UI 450, that may include a design palette area 455 and/or a workflow layout area 460, via which session metrics and/or other information, associated with a deployed FMVC workflow may be displayed. Additionally, or alternatively, FMVC application 424 may present workflow design UI 450, that may include a design palette area 455 and/or a workflow layout area 460, via which an FMVC workflow may be designed, saved, edited, and/or deployed. Design palette area 455 may include a collection of design elements that may be used (e.g., by clicking and/or dragging, with a pointing device, a desired design element from design palette area 455 to workflow layout area 460). Workflow layout area 460 may permit each design element to be positioned (e.g., with the pointing device) and/or linked in a manner that creates an FMVC workflow design that may be deployed, to network 200, to establish an FMVC workflow that may perform an electronic transaction.

As further illustrated in FIG. 4B, workflow design UI 450 may include a collection of design elements and/or buttons, such as a session initiation design element 465, an auto-transfer design element 470, an un-protected intermediate design element 475, an unprotected UI-less design element 480, a protected intermediate design element 485, a terminal design element 490, a rules-based path design element 491, a default path 492, a save button 493, a deploy button 494, a metrics button 495, an edit button 496, and/or an exit button 497. Although FIG. 4B shows workflow design UI 450, in other implementations, a workflow UI 450 may include fewer design elements and/or buttons, additional design elements and/or buttons, different design elements and/or buttons, or differently arranged design elements and/or buttons than depicted in FIG. 4B. Additionally, or alternatively, one or more design elements and/or buttons of workflow UI 450 may perform one or more tasks described as being performed by one or more other design elements and/or buttons of workflow UI 450.

Session initiation design element 465 may permit a workflow designer and/or network administrator, associated with network 200, to logically create a stage, within a workflow, that permits a session to be established. For example, session initiation element 465 may permit an initiation stage to be created that, when deployed to an FMVC workflow within network 200, may enable user device 210 to initiate a session in a manner similar to that described above with respect to initiation stage 410 of FIG. 4A. The initiation stage may include a UI, a controller, and/or a business application. In another example, a UI-less initiation design element (not shown), may permit the logical creation of an initiation stage that includes the business application, but does not include the UI and/or the controller. Auto-transfer design element 470 may enable the logical creation of a stage, within a deployed FMVC workflow, that permits the stage (e.g., based on business logic), rather than the FMVC application (e.g., FMVC application 424 of FIG. 4A), to automatically transfer a session to another stage, when a particular condition is satisfied. The auto-transfer stage may include a UI, a controller, and/or a business application.

Intermediate design element 475 may enable the logical creation of a stage, within a deployed FMVC workflow, that is neither an initiation stage nor a terminal stage and/or that may be transitioned to from any stage, at any time, and/or without a determination of whether conditions associated with a workflow rule has been satisfied. For example, intermediate design element 475 may permit the logical creation of an intermediate stage that processes information in a manner similar to that described above (with respect to intermediate stage 420 of FIG. 4A). The intermediate stage may include a UI, a controller, and/or a business application.

UI-less intermediate design element 480 may enable the logical creation of a stage, within a workflow, that is neither an initiation stage nor a terminal stage and/or that may be transitioned to from any stage, at any time, and/or without a determination of whether conditions associated with workflow rules have been satisfied. Additionally, or alternatively, UI-less intermediate design element 480 may not present information to and/or receive information from user device 210 via a UI. The intermediate UI-less stage may include the business application, but may not include a UI or a controller.

Protected intermediate design element 485 may enable the logical creation of a stage, within a workflow, that is neither an initiation stage nor a terminal stage and/or that, when deployed, is transitioned to from a particular predecessor/previous stage via paths based on workflow rules (e.g., rules-based paths). For example, protected intermediate design element 485 may permit the creation of a protected intermediate stage, within a deployed FMVC workflow, that receives a session from a particular predecessor stage based on a determination, by FMVC application 424, that workflow rules (e.g., associated with exiting the particular predecessor stage and/or entering the protected stage) have been satisfied. The protected intermediate stage may include a UI, a controller, and/or a business application.

Terminal design element 490 may enable the logical creation of a stage, within a workflow, that, when deployed, performs operations that conclude a session with user device 210. For example, terminal design element 490 may permit the creation of a terminal stage, within a deployed FMVC workflow, that performs operations that conclude the session (e.g., confirms purchase, terminates a session on request from a user device, etc.) in a manner similar to that described above (with respect to terminal stage 422 of FIG. 4A). The terminal stage may include a UI, a controller, and/or a business application and may also be a protected stage.

Rules-based path design element 491 may enable the logical creation of a workflow path, between stages within a deployed FMVC workflow, by which a session may be transferred from a particular stage to another stage. For example, rules-based path design element 491 may establish workflow rules associated with a particular stage (e.g., initiation stage 410 of FIG. 4A), that controls to which other stage and under what conditions the session is to be transferred. The workflow rules may be defined, for each rules-based path 491 in a manner that permits a designer to enter a particular set of rules that establish particular conditions, that when satisfied (e.g., by indicators contained in a business object), may cause a session to be transferred from a current stage to another stage.

As illustrated in FIG. 4B, for example, rules-based path 491 may be logically created between protected UI stage design element 485 and another protected intermediate design element 485. Rules-based path 491 may define the workflow rules that determine under what conditions a session is to be transferred from a current protected UI stage, created by protected UI stage design element 485, to another protected UI stage created by another protected UI design element 485. If, for example, a business object, received from a business application associated with the current protected UI stage, satisfies the conditions set forth by rules-based path 491, then the session may be transferred to the other protect UI stage. If, however, the FMVC application determines that the received business object does not satisfy the conditions set forth by rules-based path 491, then the session may not be transferred. Default path 492 may permit a business application to automatically transfer a session from a current stage to another stage based on business logic (e.g., without sending a business object to the FMVC application).

The design elements of workflow design UI 450 may be used to logically create the stages of an FMVC workflow as described above. The design elements may also define the variety of types of stages (e.g., session initiation stages, intermediate stages, protected stages, UI-less stages, auto-transfer stages, termination stages, etc.) to be used in the workflow. The types of stages included in the workflow may be used to identify the types of functional components to be included, for each stage (e.g., UIs, a controller, a business application, etc.), when the workflow design is deployed to network 200. Additionally, or alternatively, workflow design UI 450 may be used to define the workflow paths (e.g., rules-based path 491 and/or default path 494) between the stages of the workflow. Each rules-based path 491 may define a set of rules, triggers, and/or criteria that define the conditions under which each transfer, between the stages of the workflow, is to be made. When the workflow is undergoing design and/or when the workflow is completed, a workflow designer and/or network administrator may save the design in a memory associated with application server 240 (e.g., by selecting save button 493 on workflow design UI 450 using a pointing device and/or by pressing a particular button on a device associated with application server 240). The workflow designer and/or network administrator may edit a saved design by selecting edit button 496, which may permit changes to a saved FMVC workflow design to be made. The workflow designer and/or network administrator may exit the FMVC workflow designer by selecting exit button 497. The workflow designer and/or network administrator may, by selecting deploy button 494, initiate a deployment operation to deploy an FMVC workflow design to network 200. For example, the deployment operation may include deploying the stages and/or the logic paths that interconnect the stages to network 200 by codifying and/or storing the workflow logic, associated with the design elements and/or the arrangement thereof in workflow layout area 460, in a FMVC application, and/or a memory associated with application server 240. Additionally, or alternatively, the deployment operation may include deploying controllers (e.g., controllers 414 of FIG. 4A) for each stage that is not a UI-less stage of the FMVC workflow design and/or deploying business applications (e.g., business applications 416 of FIG. 4A) in controller server 220 and/or application server 240.

Metrics associated a deployed FMVC workflow may be obtained. For example, metrics associated with a particular session (e.g., session metrics) and/or with a collection of sessions (e.g., workflow metrics) may be obtained and/or presented via workflow design UI 450. The workflow designer and/or network administrator may use the metrics to evaluate electronic transactions (e.g., products or services selected, average transaction cost, average deposit, average time of a session, etc.), to optimize workflow, and/or to review a summary of a particular electronic transaction. Metrics may, for example, be reported for each stage (e.g., by a business application performing an operation on a business entity) and/or on entering a stage, on exiting a stage, on a determination that conditions (e.g., associated with a workflow rule) have been satisfied (e.g., conditions evaluate to be true), and/or that conditions have not been satisfied (e.g., conditions evaluate to false).

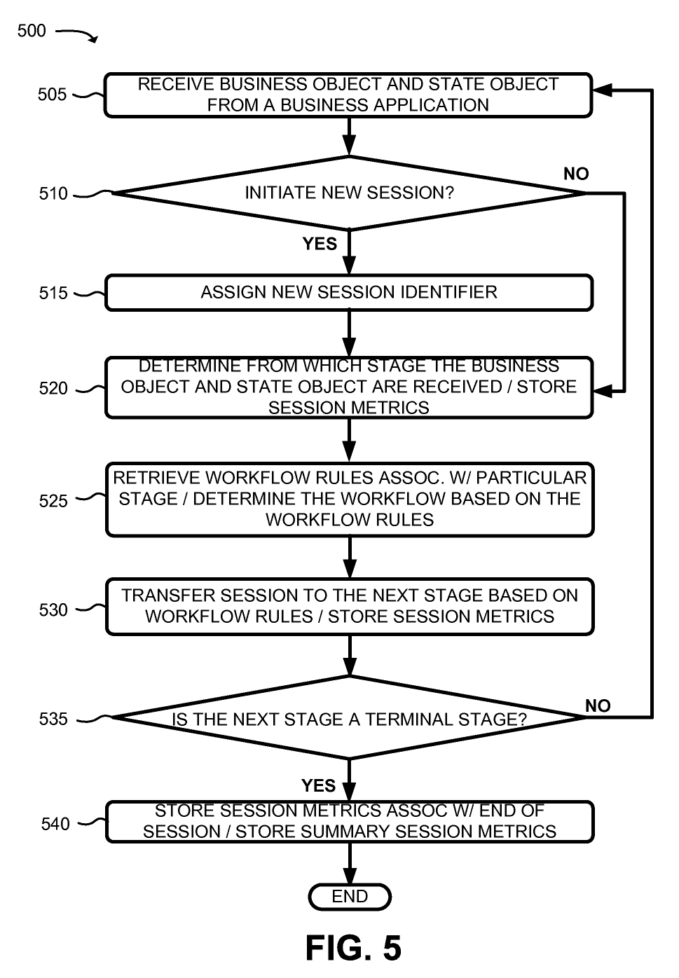

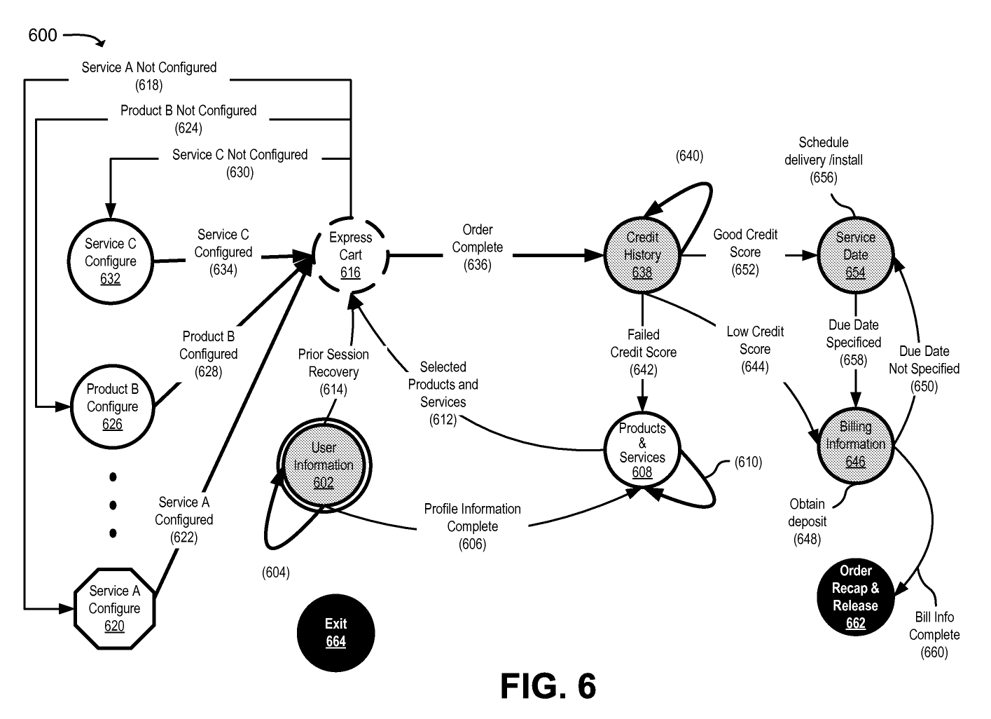

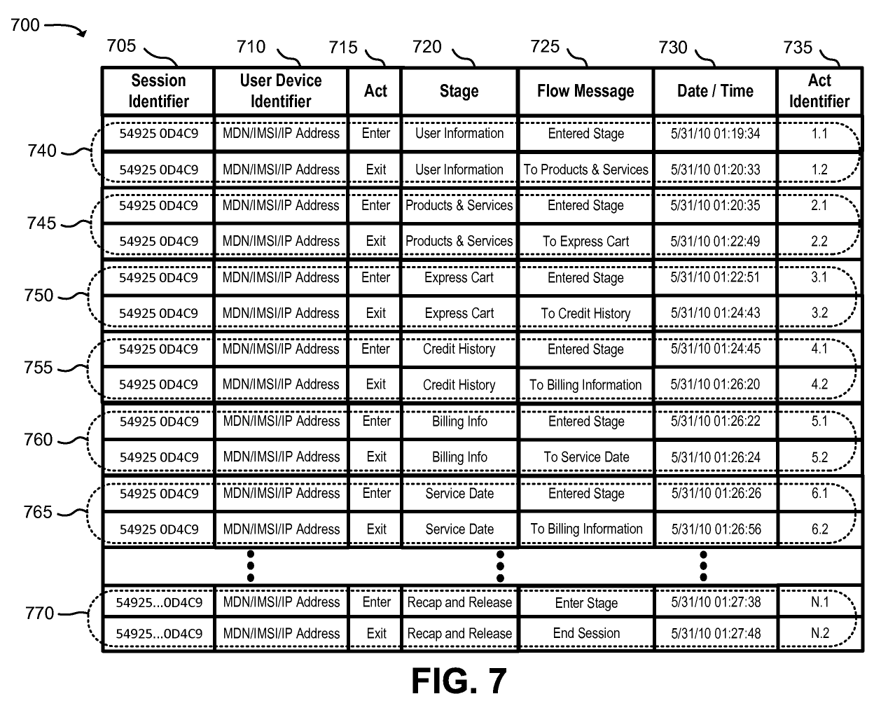

FIG. 5 is a flowchart of an example process 500 for using an FMVC workflow. In one implementation, process 500 may be performed by application server 240. In another implementation, some or all of process 500 may be performed by a device or collection of devices separate from, or in combination with, application server 240. FIG. 6 is a flow diagram of an example FMVC workflow design 600 for an electronic transaction. FIG. 7 is an example session metrics memory 700. A portion of process 500, of FIG. 5, will be discussed below with corresponding references to FMVC workflow design 600 of FIG. 6 and/or session metrics memory 700 of FIG. 7.

As shown in FIG. 5, process 500 may include receiving a business object and/or a state object from a business application (block 505). Assume that a workflow design has been created, such as workflow design 600 of FIG. 6, using a FMVC application that generates and displays a workflow UI in a manner similar to that described above (with respect to workflow design UI 450 of FIG. 4B). Assume further that the workflow design is saved and/or deployed to network 200. For example, as illustrated in FIG. 6, user information design element 602 may represent a deployed initiation stage that includes a UI, a controller, and/or a business application, which is configured to receive and/or process information received from a user, of user device 210, at the beginning of a session. The controller, associated with the initiation stage, may present a UI that is customized for display on user device 210 and may receive, via the UI, information associated with the user (e.g., username, password, PIN, etc.) and/or identifier information associated with user device 210 (e.g., MDN, IMSI, MSISDN, IP address, etc.). The controller may, for example, translate the received information into a data format/structure (e.g., a business entity) that may be received and/or processed by the business application.

The business application may, for example, determine whether the user is a new customer or an existing or prior customer by comparing the received information associated with the user and/or user device 210 with information associated with the user and/or user device 210 stored in a memory associated with the business application. If, for example, the business application determines that the received information matches the stored information, then the business application may automatically retrieve information associated with a customer profile for the user (e.g., which may include an address, a telephone phone number, products purchased, services subscribed to, session status, etc.). If, however, the business application determines that the user is a new customer (e.g., when the received information does not match the stored information), then the business application may instruct the controller to present additional UIs via which information associated with a customer profile may be obtained from user device 210. In another implementation, the business application may send the received information, associated with the user to backend server 230 in order to determine whether the user is a new customer or a prior customer. In yet another implementation, the business application may perform an authentication operation on user device 210 and/or may cause backend server 230 to perform an authentication operation on user device 210.

The business application may send a business object and/or a state object to application server 240. The business object may include information generated as a result of operations performed by the business application (e.g., indicators regarding whether user is a new or existing customer, whether user information is received, etc.). The state object may include a stage identifier (e.g., initiation stage). Additionally, or alternatively, the business application may send session metrics to application server 240 that may include information associated with a time that communication with user device 210 began (e.g., when a first communication from user device 210 was received, when user device 210 was authenticated, when information associated with the user was received, etc.), information associated with user device 210, the stage identifier (e.g., initiation stage), a workflow status (e.g., entered stage, etc.), the particular UIs presented to user device 210, and/or other information associated with the session.

Returning to FIG. 5, if a new session is initiated (block 510—YES), then a session identifier may be assigned (block 515). For example, application server 240 may receive the business object, the state object, and/or the session metrics from the business application and a, FMVC application (e.g., FMVC application 424 of FIG. 4A) may determine whether the session metrics is associated with an existing session or a new session. If, for example, the session metrics do not include a session identifier, then the FMVC application may assign a session identifier to the state information and/or the session metrics. In another implementation, the business application, associated with the initiation stage, may determine that a new session with user device 210 is to be initiated and may assign the session identifier to the new session. In yet another example, the FMVC application may determine, from the state object, that the stage associated with user information 602 is an initiation stage and may assign a session identifier.

As further shown in FIG. 5, if a new session is not initiated (block 510—NO) or after block 515, session metrics may be stored and the stage from which the business object and/or state object are received may be determined (block 520). For example, if the session metrics, received from the business application, include a session identifier, then the FMVC application may store the session metrics in a session metrics memory associated with the session identifier. Additionally, or alternatively, the FMVC application (e.g., FMVC application 424 of FIG. 4A) may use the stage identifier (e.g., obtained from the state object) to determine from which stage the business object and/or state object were received.

As yet further shown in FIG. 5, process 500 may include retrieving workflow rules associated with a particular stage and determining the workflow based on the workflow rules (block 525). For example, the FMVC application (e.g., FMVC application 424 of FIG. 4A) may retrieve, from a memory associated with application server 240, workflow rules associated with the initiation stage identified in the state object. The workflow rules may include conditions associated with a rules-based path (e.g., shown as profile information complete 606 of FIG. 6) that links the initiation stage to another stage, such as a products and services stage associated with products and services design elements 608 (FIG. 6) (e.g., shown as profile information complete 606 of FIG. 6) and/or another rules-based path (e.g., shown as prior session recovery 614 of FIG. 6) that links the initiation stage to an express cart stage associated with an express cart design element 616 (FIG. 6).

Process 500 may also include transferring the session to the next stage based on workflow rules and storing session metrics (block 530). In one example, the FMVC application (e.g., FMVC application 424 of FIG. 4A) may determine, from the workflow rules, that the next stage is not a protected stage and may automatically transfer the session to the next stage. In another example, the FMVC application may determine whether the business object, received from the business application, includes indicators that satisfy conditions associated with the workflow rules retrieved from the memory. In this example, the FMVC application may determine that the indicators satisfy the conditions (e.g., FMVC application evaluates the conditions to be true) associated with the rules-based path that links the initiation stage to another stage (e.g., a products and services stage). The FMVC application may, based on the determination, transfer the session, via a rules-based path (e.g., shown as profile information complete 606) to a products and services stage associated with products and services design element 608.

In another example, the business object, received from the business application may include an indicator that a prior session, associated with user device 210, was not complete (e.g., payment for selected products or services was not processed). In this example, the FMVC application may determine that the indicators satisfy the conditions (e.g., FMVC application evaluates the conditions to be true) associated with the rules-based path that links the initiation stage to a further stage (e.g., an express cart stage). The FMVC application may, based on the determination, transfer the session, via a rules-based path (e.g., shown as prior session recovery 614), to an express cart stage associated with express cart design element 616 (FIG. 6).

In yet another example, the FMVC application may determine that the indicators included in the business object do not satisfy the conditions associated with a rules-based path (e.g., FMVC application evaluates the conditions to false), and may not transfer the session (e.g., as indicated by path 604 of FIG. 6).

Session metrics, associated with the workflow may be stored. For example, the FMVC application may store session metrics in a session metrics memory (e.g., session metrics memory 700 of FIG. 7). As illustrated in FIG. 7, session metrics memory 700 may include a collection of entries such as a session identifier 705, a user device identifier 710, an act 715, a stage 720, a flow message 725, date/time 730, and/or an act identifier 735. Although FIG. 7 shows particular entries of session metrics memory 700, in other implementations, session metrics memory 700 may include fewer entries, additional entries, different entries, or differently arranged entries than depicted in FIG. 7. Additionally, or alternatively, one or more entries of session metrics memory 700 may perform one or more tasks described as being performed by one or more other entries of session metrics memory 700.

Session identifier 705 may store a session identifier assigned to a particular session (e.g., a session associated with user device 210) by a FMVC application or a business application associated with an initiation stage. For example, the FMVC application may store a particular session identifier (e.g., 54925 0D4C9) obtained from session metrics received from a business application associated with the particular session (e.g., as shown by ellipse 740). User device identifier 710 may store information associated with a user device (e.g., user device 210) associated with the particular session (e.g., as shown by ellipse 740). Act 715 may store an indicator regarding whether a session is entering a particular stage (e.g., being transferred from another stage) or exiting the particular stage (e.g., being transferred to another stage). Stage 720 may store a stage identifier associated with the particular session. For example, the FMVC application may store an “enter” indication when the particular session is initiated via an initiation stage (e.g., the user information stage) and/or transferred to another stage (e.g., as shown by ellipse 740). In another example, the FMVC application may store an “exit” indication when the particular session is transfer from a particular stage (e.g., the user information stage) to another stage (e.g., as shown by ellipse 740).

Flow message 725 may store a message indicating a type of flow regarding an act associated with the particular session. For example, the FMVC application may store an “entered stage” flow message when a session is initiated (e.g., with the user information stage) and/or when a session transfer, to another stage, is complete (e.g., as shown by ellipse 740). In another example, the FMVC application may store “to products & services” when the FMVC application transfers the session to the products and services stage (e.g., as shown by ellipse 740).

Date/time 730 may store a date (e.g., XX (month)/YY (day)/ZZ (year) xx (hours): yy (minutes): zz (seconds), and/or some other format) corresponding to each act 715 associated with the particular session. For example, the FMVC application may store a time and/or date (e.g., 05/31/10 01:19:34) corresponding to a point in time when the particular session, associated with user device 210, was initiated (e.g., when the session entered the user information stage) (e.g., as shown by ellipse 740). In another example, the FMVC application may store another time and/or date (e.g., 05/31/10 01:20:33) corresponding to a later point in time when the particular session was transferred to the products and services stage (e.g., as shown by ellipse 740).

Act identifier 735 may store an identifier corresponding to each act 715 associated with the particular session. The act identifier (e.g., X.Y and/or some other format) may include an indication of a quantity of stages (e.g., X) associated with the particular session and/or a quantity of acts within each stage (e.g., Y). For example, the FMVC application may store an identifier (e.g., “1.1”) corresponding to a first stage associated with the particular session (e.g., the user information stage) and/or a first act (e.g., entering the stage) associated with the first stage (e.g., as shown by ellipse 740). In another example, the FMVC application may store another identifier (e.g., “1.2”) corresponding to another act (e.g., a second act) associated with the first stage (e.g., as shown by ellipse 740).

Returning to FIG. 5, if the next stage is not a terminal stage (block 535—NO), then process 500 may include receiving a business object and a state object associated with another stage may be received from a business application (block 505). For example, a business application, associated with a products and services stage, may send a business entity instructing a controller to render a UI or set of UIs for display on user device 210 that permits the user to view products or services and/or to select products and/or services for purchase. For example, the business application may receive a business entity from the controller that includes information associated with the selected products received from user device 210 via the UI. The business application may, for example, process the business entity that includes the selected products and/or services and may, in a manner similar to that described above (e.g., with respect to block 505), send a business object and/or a state object to application server 240. The state object may include a stage identifier (e.g., products and services stage). The business object may include an indication that a selection has been made, information associated with the selected products and/or services, etc.

The business application may send session metrics to application server 240. The session metrics may, for example, include a session identifier, information associated with the user device, a stage identifier (e.g., products and services stage), the UIs rendered on user device 210, the selected products and/or services, a time associated with a point in time that the session entered the stage, etc. Application server 240 may receive the session metrics and the FMVC application may store all or a portion of the session metrics in a session metrics memory (e.g., session metrics memory 700 of FIG. 7) as described below.

A transfer operation may be performed. For example, the FMVC application may receive, from the business application associated with products and services stage, the state object and/or the business object. The FMVC application may, in a manner similar to that described above, with respect to blocks 520-530, retrieve workflow rules, associated with the current stage (e.g., the products and services stage as identified by the state object), and may determine whether the conditions identified in the workflow rules are satisfied by the indicators (e.g., that the products and/or services were processed, that a selection was received from user device 210, etc.) contained in the business entity. For example, the FMVC application may determine that the indicators satisfy the conditions (e.g., FMVC application evaluates the conditions to be true) associated with the rules-based path that links the current stage to another stage (e.g., an express cart stage). The FMVC application may, based on the determination, transfer the session, via a rules-based path (e.g., shown as selected products and services 612 of FIG. 6), to an express cart stage associated with express cart design element 616 (FIG. 6).

The FMVC application may store session metrics. For example, the FMVC application may, in a manner similar to that described above (with respect to block 530), store session metrics in a session metrics memory (e.g., session metrics memory 700 of FIG. 7). As illustrated in FIG. 7, FMVC application may store session metrics associated with the transfer of the session to the products and services stage, that may include storing “54925 0D4C9” in session identifier 705, a user device identifier (e.g., MDN, IMSI, IP address, etc.) in user device identifier 710, “enter” in act 715, “products and services” in stage 720, “entering stage” in flow message 725, a point in time when the session entered the products and services stage (e.g., 05/31/10 01:20:35) in date/time 730, and/or an “2.1” in act identifier 735 (e.g., as shown by ellipse 745 of FIG. 7). The FMVC application may also store session metrics in the session metrics memory associated with the transfer of the session from the products and services stage to an express cart stage, that may include storing the session identifier and/or the user device identifier, as described above as well as “exit” in act 715, “products and services” in stage 720, “to express cart” in flow message 725, a point in time when the session was transferred to the express cart stage (e.g., 05/31/10 01:22:49) in date/time 730, and/or “2.2” in act identifier 735 (e.g., as shown by ellipse 745 of FIG. 7).

In a manner similar to that described above with respect to (block 535—NO), the FMVC application may determine that the next stage is not a terminal stage and the session may be transferred to the next stage (e.g., the express cart stage). For example the express cart stage may include a UI, or set of UIs, a controller, and/or a business application. Additionally, or alternatively, the express cart stage may be an auto-transfer stage in which the session may be automatically transferred (e.g., by the business application) to another stage (e.g., credit history stage associated with credit history design element 638 of FIG. 6), when particular conditions are satisfied (e.g., based on business logic) and without intervention from and/or involvement by the FMVC application. For example, the business application may determine that the selected products and/or services include service A, product B, and/or service C have all been configured and may (e.g., based on business logic) automatically transfer the session to another stage (e.g., a credit history stage associated with credit history design element 638 of FIG. 6),

In another example, the business application may determine that the selected products and/or services were not configured for the user and may send a business object and/or a state object to the FMVC application. For example, the FMVC application (FMVC application 424 of FIG. 4) may identify the current stage (e.g., from the state object) and may retrieve workflow rules associated with the current stage. Based on the workflow rules, the FMVC application may determine that other stages are not protected stages and may transfer the session to another stage, or collection of stages (e.g., stages associated with service C configure design element 632, product B configure design element 626, and/or service A configure design element 620). The session may, for example, be transferred via a path or set of paths (e.g., service C not configured design element 630, product B design element not configured 624, and/or service A not configured design element 618, respectively) (FIG. 6) in order for the selected products and/or services to be configured.

In one example, service A configuration stage may be a UI-less stage that may perform configuration operations associated with service A that may not include a controller and/or a UI via which information may be presented to and/or received from the user. For example, the configuration operations may include identifying, in a manner that is transparent to the user, particular hardware and/or software upgrades that may be included with service A to permit proper delivery to the user. In another example, service C configuration stage and/or product B configuration stage may perform configuration operations to enable particular features, associated with service C and/or product B, respectively, that address the desires and/or preferences of the user (e.g., obtained via the UIs rendered on user device 210) and/or to ensure that the selected products and/or services are configured to be mutually compatible and/or properly bundled (e.g., when two or more products and/or services are selected for purchase by a user). When the configuration operations are complete, service A configuration stage, product B configuration stage, and/or service C configuration stage may transfer the session back, to express cart stage 616, via default paths (e.g., as shown by service A configured 622 (FIG. 6), product B configured 628 (FIG. 6), and/or service C configured 634 (FIG. 6)). The business application associated with the express cart may receive the session and may, in a manner similar to that described above, determine that the selected products and/or services have been configured and may automatically transfer the session to another stage, such as the credit history stage, associated with credit history design element 638 (FIG. 6).

The FMVC application may store session metrics associated with the workflow. For example, the FMVC application may, in a manner similar to that described above (with respect to block 530), store session metrics, for the session associated with user device 210, in a session metrics memory (e.g., session metrics memory 700 of FIG. 7). As illustrated in FIG. 7, FMVC application may store session metrics associated with the session transfer to and/or from the express cart stage that may include storing “54925 0D4C9” in session identifier 705, a user device identifier (e.g., MDN, IMSI, IP address, etc.) in user device identifier 710, “enter” in act 715, “express cart” in stage 720, “entered stage” in flow message 725, a point in time when the session entered the express cart stage (e.g., 05/31/10 01:22:51) in date/time 730, and/or an “3.1” in act identifier 735 (e.g., as shown by ellipse 750 of FIG. 7). The FMVC application may also store session metrics in the session metrics memory associated with the session transfer to the credit history stage, which may include storing the session identifier and/or the user device identifier (as described above), “exit” in act 715, “express cart” in stage 720, “to credit history” in flow message 725, a point in time when the session was transferred to the credit history stage (e.g., 05/31/10 01:24:43) in date/time 730, and/or “3.2” in act identifier 735 (e.g., as shown by ellipse 750 of FIG. 7).

Additionally, or alternatively, the FMVC application may receive other session metrics from the business application associated with the express cart stage that may include information associated with user preferences associated with selected products and/or services, UI pages rendered on user device 210, pricing and/or rate information associated with the configured products and/or services selected by the user, and/or other information associated with the express cart stage and/or stages associated with configuring products and/or services. The FMVC application may store the other session metrics in a session metrics memory and/or in a customer profile as described above.

Returning to FIG. 5, and in a manner similar to that described above with respect to (block 535—NO), the FMVC application receive a business object and/or a state object from a business application. For example the credit history stage, associated with credit history design element 638 (FIG. 6) may be an intermediate stage that includes a UI, or set of UIs, a controller, and/or a business application. Additionally, or alternatively, the credit history stage may be a protected stage that may be access by a particular predecessor stage (e.g., the express cart stage). For example, the business application may send a business entity instructing a controller, associated with the credit history stage, to render a UI, on user device 210, via which confidential information associated with the user (e.g., an SSN and/or other confidential information), may be obtained. The business application may, for example, receive a business entity from the controller that includes the confidential information.

The business application may obtain credit history information in a number of ways. In one example, the business application may communicate with backend server 230 to obtain credit history information associated with the user obtained during a prior session. In another example, backend server 230 may communicate with web server 250 to obtain credit history information. In this example, web server 250 may provide and/or permit access to credit history information associated with the user. The business application may receive the credit history information from backend server 230 and may, for example, send a business object and/or a state object to the FMVC application. Additionally, or alternatively, the business application may, in a manner similar to that described above, with respect to blocks 520-530, store all or a portion of the session metrics in a session metrics memory (e.g., as shown by ellipse 755 of session metrics memory 700 of FIG. 7).

For example, the FMVC application may receive the business object and/or the state object and may, in a manner similar to that described above (e.g., with respect to blocks 520-530), retrieve workflow rules associated with the current stage (e.g., the credit history stage as identified by the state object). The FMVC may determine whether the conditions identified in the workflow rules are satisfied by the indicators contained in the business entity (e.g., confidential information received, information associated with a credit history obtained, etc.).

In one example, the FMVC application may determine that a measure of creditworthiness (e.g., a credit rating), obtained from the business object, is less than or equal to a low credit score threshold, as specified in the workflow rules. In this example, the FMVC may determine that a condition associated with a particular workflow path that links the current stage to another stage (e.g., products and service stage) is satisfied (e.g., FMVC application evaluates the condition to be true). For example, the FMVC application may, based on the determination, transfer the session, via a rules-based path (e.g., shown as failed credit score 642 of FIG. 6), to a products and services stage (e.g., associated with products and service design element 608 (FIG. 6) that permits the user to select products and/or services for which the user qualifies.

In another example, the FMVC application may determine that the credit rating, obtained from the business object, is greater than the low credit score threshold, but less than or equal to a high credit score threshold as specified in the workflow rules associated with another rules-based path. In this example, the FMVC may determine that a condition associated with the other rules-based path that links the current stage to another stage (e.g., a billing information stage) is satisfied (e.g., FMVC application evaluates the condition to be true). For example, the FMVC application may, based on the determination, transfer the session, via a rules-based path (e.g., shown as low credit score 644 of FIG. 6), to the billing information stage (e.g., associated with billing information stage design element 646 (FIG. 6) that enables the user to submit a deposit for the selected products and/or services (e.g., shown as obtain deposit 648). FMVC application may transfer the session, in the manner described above (e.g., based on a business object, a state object and workflow rules), to the service date stage via a rules-based path (e.g., as shown by due date not specified 650 of FIG. 6).

In yet another example, the FMVC application may determine that the credit rating is greater than the high credit score threshold, and in a manner similar to that described above, may transfer the session, via yet another rules-based path (e.g., shown as good credit score 652) to another stage (e.g., a service date stage associated with service date design element 654 of FIG. 6) to schedule the delivery of selected products and/or the installation of selected services (e.g., as shown by schedule delivery/install 656 of FIG. 6). FMVC application may transfer the session, in the manner described above (e.g., based on a business object, a state object and workflow rules), to the billing information stage via a rules-based path (e.g., as shown by due date specified 658 of FIG. 6).

In a manner similar to that described above, with respect to blocks 520-530, all or a portion of the session metrics (e.g., associated with the session transfers to the service dates stage and/or the billing informant stage) may be stored in a session metrics memory (e.g., as shown by ellipses 760 and 765 of session metrics memory 700 of FIG. 7).

In still another example, the FMVC application may determine that conditions associated with the workflow rules (e.g., as described above) were satisfied (e.g., FMVC evaluated the conditions to false) and may not transfer the session (e.g., shown as indication 640 of FIG. 6).

If the next stage is a terminal stage (block 535-YES), then session metrics, associated with the termination of the session may be stored and process 500 may end (block 540). For example, the FMVC application (e.g., FMVC application 424 of FIG. 4A) may, receive a business object and/or a state object from a business application associated with the billing stage (e.g., associated with billing information design element 646 of FIG. 6). In a manner similar to that described above with respect to blocks 520-530, the FMVC application may retrieve workflow rules associated with the billing stage and may determine whether the indicators included in the business object satisfy the conditions included in the workflow rules retrieved from the memory. In this example, the FMVC application may determine that the indicators (e.g., that the order, associated with the selected products and/or services was completed; that a credit history was obtained; that a service/shipping address was obtained and/or a service date was scheduled; that billing information was received; that payment for a deposit (if necessary) and/or the selected products and/or services was processed; that a confirmation number was generated; and/or that other information associated with the session was included) that are identified in the workflow rules as a condition to transfer the session to a terminal stage (e.g., associated with order recap and release design element 662 of FIG. 6).

For example, based on the determination, the FMVC application may transfer the session to the terminal stage (e.g., the order recap and release stage) via a rules-based path (e.g., as shown by billing information complete 660 of FIG. 6). Additionally or alternatively, the business application, associated with the billing stage, may store all or a portion of the session metrics in a session metrics memory (e.g., not shown in session metrics memory 700 of FIG. 7).

The order recap and release stage may, for example, be a terminal stage that is used by the FMVC application to conclude the session with user device 210. For example, the business application, associated with the recap and release stage, may retrieve session metrics from a session metrics memory and may send a business entity instructing a controller to render a UI that includes a receipt for the electronic transaction that includes information associated with the session, such as the confirmation number, the selected products and/or services, the prices associated with the selected products and/or services, the amount of the deposit collected, the amount of the payment for the selected products, the billing information used to process the deposit and/or the payment, and/or the shipping and/or service address.

In another example, the FMVC application may determine that an a condition included in the workflow rules associated with the terminal stage, was not included in the received business entity (e.g., a shipping address) and may transfer the session to another stage (e.g., a non-terminal stage) to obtain the missing indicator(s).

The FMVC application may store session metrics associated with the conclusion of the session. For example, the FMVC application may store session metrics, for the session associated with user device 210, in a session metrics memory (e.g., session metrics memory 700 of FIG. 7). As illustrated in FIG. 7 (e.g., by ellipse 770), the FMVC application may store session metrics, associated with the transfer to the recap and release stage, that may include storing “54925 0D4C9” in session identifier 705, a user device identifier (e.g., MDN, IMSI, IP address, etc.) in user device identifier 710, “enter” in act 715, “recap and release” in stage 720, “enter stage” in flow message 725, a point in time when the session entered the terminal stage (e.g., 05/31/10 01:27:38) in date/time 730, and/or an “N.1” in act identifier 735. The FMVC application may also store session metrics in the session metrics memory associated with the termination of the session that may include storing the session identifier and/or the user device identifier (as described above), “exit” in act 715, “recap and release” in stage 720, “end session” in flow message 725, a point in time when the session was terminated (e.g., 05/31/10 01:27:48) in date/time 730, and/or “N.2” in act identifier 735.

It should be understood that during any non-terminal stage of the FMVC workflow and/or prior to a confirmation number being issued, a user, of user device 210, may terminate the transaction by exiting the FMVC workflow, via an exit stage, associated with exit design element 664 (FIG. 6). In a manner similar to that described above, the FMVC application may store the session metrics associated with the terminated session.

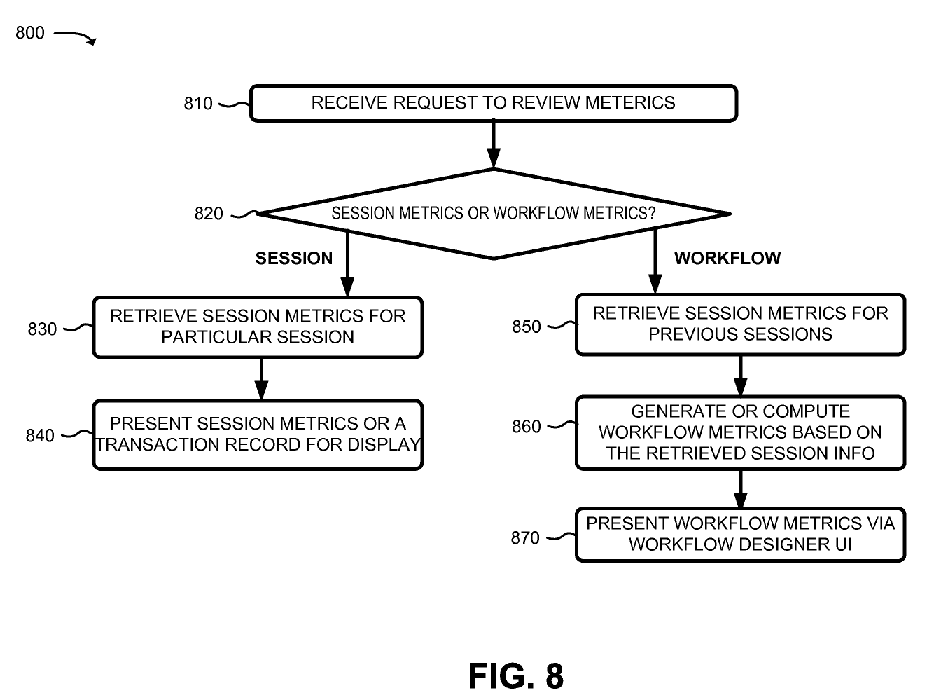

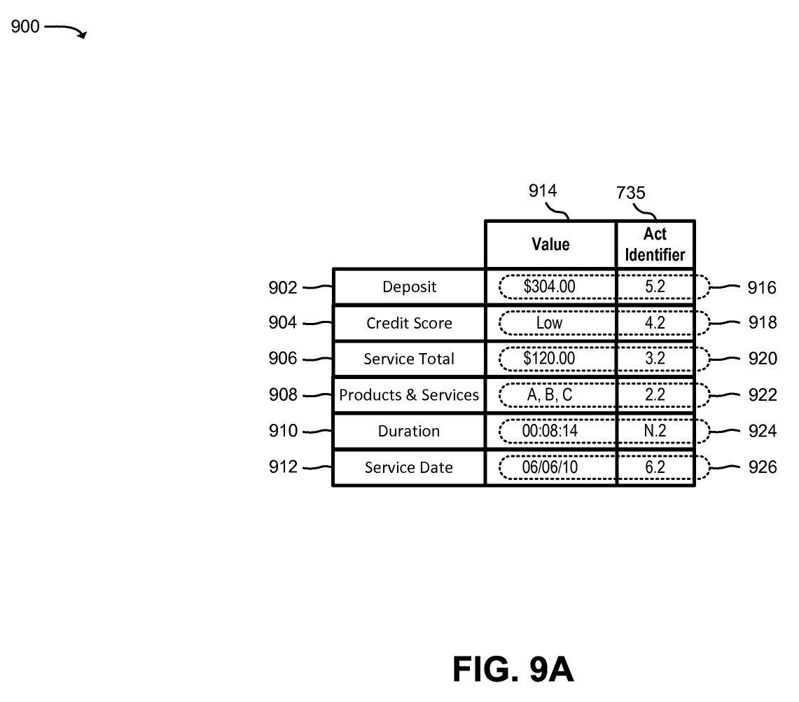

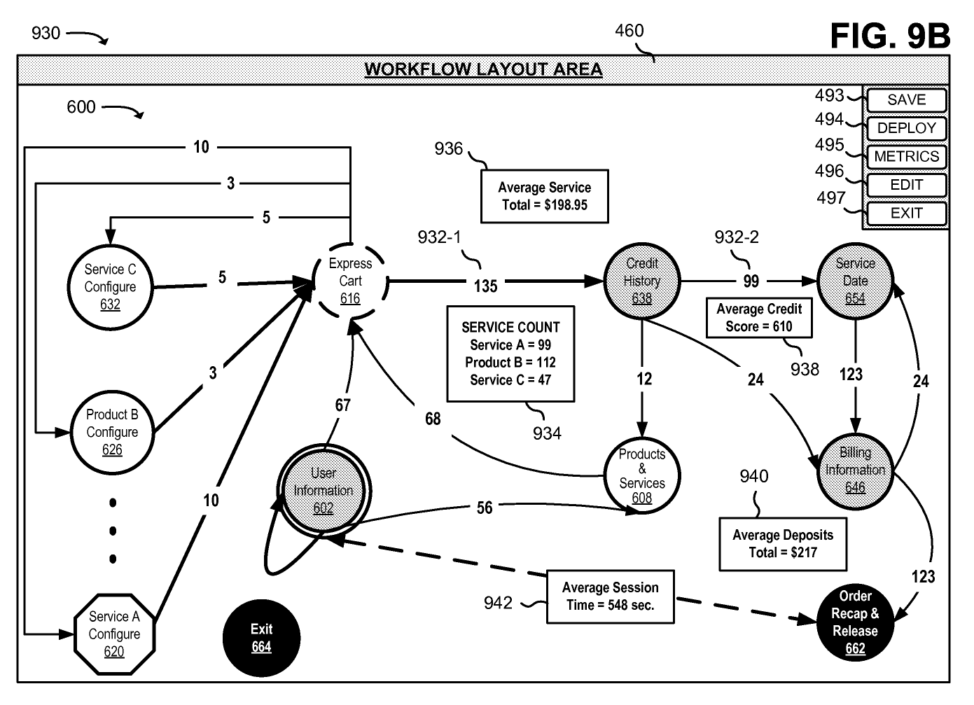

FIG. 8 is a flowchart of an example process 800 for reviewing session metrics or workflow metrics. In one implementation, process 800 may be performed by application server 240. In another implementation, some or all of process 800 may be performed by a device or collection of devices separate from, or in combination with, application server 240. FIG. 9A is diagram of an example electronic transaction record 900. FIG. 9B is a diagram of example FMVC workflow metrics 930 capable of being displayed, via workflow layout area 460 of FIG. 4B. A portion of process 800, of FIG. 8, will be discussed below with corresponding references to electronic transaction record 900 of FIG. 9A and/or workflow metrics 930 of FIG. 9B.

Process 800, of FIG. 8, may include receiving a request to review metrics (block 810). For example, application server 240 may receive a request, from a workflow designer and/or network administrator and via workflow design UI 450 (e.g., when metrics button 495, of workflow design UI 450 of FIG. 4B, is selected), to review metrics associated with a particular session (e.g., a session associated with user device 210) and/or with a collection of sessions. The FMVC application may, in response to the request, display a UI that permits the workflow designer and/or network administrator to indicate whether session metrics are desired (e.g., when a particular session identifier is received via the UI) or workflow metrics are desired (e.g., when a collection of session identifiers are received via the UI). In another implementation, workflow metrics may be requested via another UI that permits the workflow designer and/or network administrator to enter a date/time, or a range of dates/times, during which sessions were conducted. In yet another implementation, workflow metrics may be requested via yet another UI that permits the workflow designer and/or network administrator to enter a user device identifier (e.g., user device identifier 710 of FIG. 7) associated with a session, or collection of sessions, with a particular user device 210 that corresponds to the entered user device identifier.

If session metrics are requested (block 820—SESSION), then session metrics for a particular session may be retrieved (block 830). For example, if application server 240 receives a request to review session metrics, then the FMVC application may retrieve, from a memory associated with application server 240 (e.g., session metrics memory 700 associated of FIG. 7), session metrics corresponding to a session identifier (e.g., 54925 0D4C9) included in the request.

Process 800 may also include presenting session metrics or a transaction record for display (block 840). For example, the FMVC application may present the received session metrics (e.g., stored in session metrics memory 700 of FIG. 7) for display on a display device associated with application server 240. The FMVC application may present a transaction record associated with the particular session. For example, the FMVC application may use the session metrics to determine a duration of the session based on a point in time that the session was initiated (e.g., 5/31/10 01:19:34 stored in date/time 730 of FIG. 7) corresponding to a first act identifier (e.g., 1.1 stored in act identifier 735 of FIG. 7), to a later point in time that the session was terminated (e.g., 5/31/10 01:27:48 stored in date/time 730 of FIG. 7) corresponding to a last act identifier (e.g., N.2 stored in act identifier 735). Additionally, or alternatively, the FMVC application may retrieve, from the memory, other information associated with the session identifier and may store the other information, information associated with the duration of the session, and/or other information in a transaction record (e.g., electronic transaction record 900 of FIG. 9A).

As illustrated in FIG. 9A, for example, electronic transaction record 900 may include a collection of fields, such as a deposit field 902, a credit score field 904, a service total field 906, a products and services field 908, a duration field 910, and/or a service date field 912. Additionally, or alternatively, electronic transaction record 900 may include a value entry 914 and/or act identifier 735 of FIG. 7. Although FIG. 9A shows example fields and/or entries of electronic transaction record 900, in other implementations, electronic transaction record 900 may include fewer fields and/or entries, additional fields and/or entries, different fields and/or entries, or differently arranged fields and/or entries than depicted in FIG. 9A. Additionally, or alternatively, one or more fields and/or entries of electronic transaction record 900 may perform one or more tasks described as being performed by one or more other fields and/or entries of electronic transaction record 900.

Deposit field 902 may store a value that corresponds to a deposit obtained during a particular session (e.g., the session associated the identifier included in the request). For example, the FMVC application may store a value that corresponds to a deposit that was obtained during the billing information stage (e.g., for $304.00 during act identifier 5.2 as shown by ellipse 916 of FIG. 9A). Credit score field 904 may store a measure of creditworthiness obtained during the particular session. For example, the FMVC application may store the credit score and/or the particular threshold associated with the credit score that was obtained during credit history stage of the workflow (e.g., a low credit score obtained during act identifier 4.2 as shown by ellipse 918 of FIG. 9A). Service total field 906 may store a payment amount that was processed during the particular session. For example, the FMVC application may store a value that corresponds to a payment amount that was processed during the billing information stage of the workflow (e.g., for $120.00 during act identifier 3.2 as shown by ellipse 920 of FIG. 9A). Products and services field 908, may store the selected products and services obtained during the particular session. For example, the FMVC application may store the selected products or services that were included in the express cart stage of the workflow (e.g., service A, product B, service C, and/or some other product or service during act identifier 2.2 as shown by ellipse 922 of FIG. 9A).

Duration field 910 may store a period of time associated with the particular session as described above (e.g., 00:08:14 associated with the last act identifier N.2 as shown by ellipse 924 of FIG. 9A). Service date 912 may store a value associated with a date on which products or services may be rendered. For example, the FMVC application may store a value associated with a date on which products may be shipped and/or services may be installed/delivered that was determined during the service date stage of the workflow (e.g., 06/06/10 identified during act identifier 6.2 as shown by ellipse 926 of FIG. 9A). The FMVC application may present the transaction record for display on a display device associated with application server 240.

In another example, a transaction may include other metrics not shown in transaction record 900, such as the views (e.g., UIs) that were displayed to user device 210. In yet another example, the particular workflow (e.g., the particular rules-based paths, default paths, and/or stages) associated with the session.

Returning to FIG. 8, if workflow metrics are requested (block 820—WORKFLOW), then session metrics for previous sessions may be retrieved (block 850). For example, if application server 240 receives a request to review workflow metrics, then the FMVC application may retrieve, from a memory associated with application server 240, session metrics (e.g., from session metrics memory 700 of FIG. 7) and/or information associated with a transaction record (e.g., transaction record 900 of FIG. 9A) associated with a collection of prior sessions that correspond to session identifiers included in the request.

Process 800 may also include generating or computing workflow metrics based on retrieved session metrics (block 860). For example, the FMVC application may generate, from the retrieved session metrics, workflow metrics associated with the collection of prior sessions. The generated workflow metrics may include, for example, a quantity of sessions that enter and/or exit each stage of the FMVC workflow. In another example, the generated workflow metrics may include a quantity of each type of product or service (e.g., service A, product B, service C, and/or other products or services) and/or bundles of products and/or services (e.g., when a user of user device 210 orders more than one product and/or services). Additionally, or alternatively, the FMVC application may compute, from the information associated with a transaction record for each prior session, workflow metrics associated with the collection of prior sessions. The computed workflow metrics may include, for example, an average service total based on a service total (e.g., service total 906 of FIG. 9A) for each of the prior sessions. In another example, the computed workflow metrics may include an average credit score based on a credit score obtained for each of the prior sessions. In yet another example, the workflow metrics may include an average deposit based on a deposit (e.g., deposit 902 of FIG. 9A) for each of the prior sessions. In still another example, the workflow metrics may include an average session time based on a duration (e.g., duration 910 of FIG. 9A) for each of the prior sessions.

Process 800 may further include presenting workflow metrics for display via a workflow UI (block 870). For example, as illustrated in FIG. 9B, the FMVC application may present, for display on a display device associated with application server 240, the generated workflow metrics and/or the computed workflow metrics via a workflow UI (e.g., workflow design UI 450 of FIG. 4B). In this example, the FMVC application may display FMVC workflow 600 (FIG. 6) via workflow layout area 460 (FIG. 4B) of workflow design UI 450. Additionally, or alternatively, the FMVC application may present, for display via workflow layout area 460, the quantity of prior sessions associated with each rules-based path and/or default path of FMVC workflow 600. For example, as shown in FIG. 9B, “135” prior sessions (e.g., shown as 932-1) may have been transferred between an express cart stage associated with express cart design element 616 (FIG. 6) and a credit history stage associated with credit history stage design element 638 (FIG. 6). In another example, as shown in FIG. 9B, “99” prior sessions (e.g., shown as 932-2) may have been transferred between a credit history stage and a service date stage associated with service date design element 654 (FIG. 6).

In another example, as illustrated in FIG. 9B, the FMVC application may present, for display via workflow layout area 460, a total service count 934 (e.g., service A=99, product B=112, service C=47, etc.) that may include a total quantity of each product, service, and/or bundles of products and/or services purchased as a result of the collection of prior sessions. In yet another example, as illustrated in FIG. 9B, the FMVC application may present, for display via workflow layout area 460, an average service total 936 (e.g., $198.95) for the products, services, and/or bundles of products and/or services purchases as a result of the collection of prior sessions. In still another example, as illustrated in FIG. 9B, the FMVC application may present, for display via workflow layout area 460, an average credit score 938 (e.g., “610”) associated with users of user devices 210 with which the collection of prior sessions were conducted. In yet another example, as illustrated in FIG. 9B, the FMVC application may present, for display via workflow layout area 460, an average deposit 940 (e.g., $217.00) obtained from users determined to have a low credit score as a result of the collection of prior sessions. In still another example, as illustrated in FIG. 9B, the FMVC application may present, for display via workflow layout area 460, an average session time 942 (e.g., “548 seconds”) associated with the collection of prior sessions.

The workflow designer and/or the network administrator may use the workflow metrics to obtain business insights into sales, volume, product types, service type, bundles, etc.), to optimize the workflow logic to reduce congestion associated with particular stages and/or paths, to reduce average session times, to affect the average deposit (e.g., to increase, to decrease, to remain the same, etc.), to estimate affects on session times due to changes to the workflow logic and/or business logic. Additionally, or alternatively, the workflow designer and/or network administrator may use information stored in the session metrics, workflow metrics and/or transaction record to change the FMVC workflow design. For example, the workflow designer may use the workflow UI 450 to edit an FMVC workflow (e.g., FMVC workflow 600 of FIG. 6) by selecting edit button 496 (FIG. 4B) and changing workflow rules, workflow paths, and/or stage design elements (e.g., types, location, etc.), and/or increasing or decreasing the quantity of stages and/or paths associated with the FMVC workflow. The workflow designer may, in a manner that does not disrupt the electronic transaction service, deploy the edited FMVC workflow design to a network (e.g., network 200).

Implementations described herein may provide an FMVC workflow that enables electronic transactions, across multiple channels to be performed and/or monitored, by a FMVC application. The FMVC application may permit an FMVC workflow to be designed using a collection of design elements that enable workflow logic to be established for the FMVC workflow. The FMVC application may further permit an FMVC workflow design to be deployed to a network in which the workflow logic is codified in the FMVC application and stages and/or paths between stages, via which a session may be transferred, may be established based on the design elements used in the FMVC workflow design. The FMVC application may receive a business object and/or state object from a stage, associated with a deployed FMVC workflow and may determine whether the business object contains identifiers that satisfy conditions included workflow rules associated with the stage (e.g., as identified by the state object). The FMVC application may transfer the session to another stage based on a determination that the indicators satisfy the conditions contained in the workflow rules (e.g., when the FMVC application evaluates the conditions to be true) and/or may store session metrics in a session metrics memory associated with each stage via which the session was transferred. The FMVC application may receive a request to display metrics regarding a deployed FMVC workflow associated with a particular session and/or a collection of prior sessions and may present session metrics and/or workflow information, for display, based on retrieved session metrics associated with the particular session and/or the collection of prior sessions.

The foregoing description provides illustration and description, but is not intended to be exhaustive or to limit the invention to the precise form disclosed. Modifications and variations are possible in light of the above teachings or may be acquired from practice of the invention.

While a series of blocks has been described with regard to FIGS. 5 and 8, the order of the blocks may be modified in other implementations. Further, non-dependent blocks may be performed in parallel.

It will be apparent that systems and methods, as described above, may be implemented in many different forms of software, firmware, and hardware in the implementations illustrated in the figures. The actual software code or specialized control hardware used to implement these systems and methods is not limiting of the invention. Thus, the operation and behavior of the systems and methods were described without reference to the specific software code—it being understood that software and control hardware can be designed to implement the systems and methods based on the description herein.

Further, certain portions, described above, may be implemented as a component that performs one or more functions. A component, as used herein, may include hardware, such as a processor, an application-specific integrated circuit (ASIC), or a field-programmable gate array (FPGA), or a combination of hardware and software (e.g., a processor executing software).

It should be emphasized that the terms “comprises”/“comprising” when used in this specification are taken to specify the presence of stated features, integers, steps or components but does not preclude the presence or addition of one or more other features, integers, steps, components or groups thereof.

Even though particular combinations of features are recited in the claims and/or disclosed in the specification, these combinations are not intended to limit the disclosure of the invention. In fact, many of these features may be combined in ways not specifically recited in the claims and/or disclosed in the specification. Although each dependent claim listed below may directly depend on only one other claim, the disclosure of the invention includes each dependent claim in combination with every other claim in the claim set.

No element, act, or instruction used in the present application should be construed as critical or essential to the invention unless explicitly described as such. Also, as used herein, the article “a” is intended to include one or more items. Where only one item is intended, the term “one” or similar language is used. Further, the phrase “based on” is intended to mean “based, at least in part, on” unless explicitly stated otherwise.

What is claimed is:

1. A method performed by a server device, the method comprising:
presenting, via a workflow user interface (UI) generated by the server device, a workflow design that, when deployed, creates a workflow via which an electronic sales transaction with a user device is to be conducted, the workflow UI including a plurality of design elements that correspond to a plurality of stages associated with the workflow and one or more logical paths interconnecting the stages;
receiving, via the workflow UI, a request to deploy the workflow design to a network associated with the server device;
deploying, by the server device to the network and in response to the request, the plurality of design elements to create the workflow, where
the workflow includes the plurality of stages and the one or more logical paths associated with a condition that, when satisfied, permit the stages to be interconnected,
each stage, of the plurality of stages, is interconnected by at least one logical path of the one or more logical paths and generates a business object that includes information regarding an operation associated with the electronic sales transaction, and
the workflow permits one or more of the plurality of stages to be edited, via the workflow UI, in a manner that does not disrupt operation of the deployed workflow; and
conducting, by the server device, the electronic sales transaction with the user device by transferring the electronic sales transaction between two or more stages of the plurality of stages, via the at least one logical path provided between the two or more stages, where transferring the electronic sales transaction is based on a determination that the business object, received from one of the two or more stages, satisfies the condition associated with the at least one logical path.

2. The method of claim 1, where one or more of the plurality of design elements, when deployed to the network, creates one of the plurality of stages that is to be used to initiate the electronic sales transaction.

3. The method of claim 1, where deploying the plurality of design elements to create the workflow further includes:
storing, in a memory associated with the server device, workflow rules that include the condition associated with the one or more logical paths; and
storing, in the memory, a different one of a plurality of business applications for each stage of the plurality of stages, the different one of the plurality of business applications performing operations associated with a corresponding stage of the plurality of stages.

4. The method of claim 9, where deploying the plurality of design elements to create the workflow further includes:
storing, in a memory, controller logic for one or more controllers associated with one or more stages of the plurality of stages, where each of the one or more controllers:
corresponds to a different one of the one or more stages, and
renders one or more UIs on the user device that permit information, associated with the different one of the one or more stages, to be presented to the user or received from the user.

5. The method of claim 1, where conducting the electronic sales transaction with the user device includes:
receiving the business object and a state object from an initiation stage of the plurality of stages, the business object including an indicator associated with an operation performed by the initiation stage, the state object including an identifier associated with the initiation stage;
retrieving, from a memory associated with the server device and based on the identifier associated with the initiation stage, workflow rules associated with the initiation stage, the workflow rules including a condition that, when satisfied, causes the server device to transfer the electronic sales transaction to another stage of the plurality of stages;
comparing the indicator, associated with the operation performed by the initiation stage, with the condition included in the workflow rules associated with the initiation stage;
determining that indicator satisfies the condition when the indicator matches the condition based on the comparison; and
transferring the electronic sales transaction to the other stage based on the determination that the indicator satisfies the condition, where the other stage permits the user to select the particular products or services.

6. The method of claim 1, where conducting the electronic sales transaction with the user device includes:
receiving the business object from an intermediate stage of the plurality of stages, the business object including an indicator that a date, on which a particular act is to occur, has been established;
retrieving, from a memory associated with the server device, workflow logic associated with the intermediate stage, the workflow logic including a condition that the date on which the particular act is to occur is to be established in order to transfer the electronic sales transaction to another stage of the plurality of stages;
transferring the electronic sales transaction to the other stage based on the indicator, that the date on which the particular act is to occur has been established, satisfies the condition that the date on which the particular act is to occur is to be established.

7. The method of claim 1, where conducting the electronic sales transaction with the user device includes:
receiving a business object from a particular stage of the plurality of stages, the business object including an indicator of creditworthiness of the user; and
transferring, via the at least one logical path, the electronic sales transaction to:
a first stage, of the plurality of stages, when the indicator of creditworthiness is less than a low credit threshold, where the first stage permits the user to select other products or services for which the user qualifies,
a second stage, of the plurality of stages, when the indicator of creditworthiness is greater than the low credit threshold and less than a high credit threshold, where the second stage collects a deposit from the user, and
a third stage, of the plurality of stages, when the indicator of creditworthiness is greater than the high credit threshold, where the third stage establishes a date for the delivery of the particular products or services.

8. The method of claim 1, further comprising:
receiving another request to view session metrics associated with the electronic sales transaction;
retrieving, from a memory associated with the server device and in response to the other request, session metrics associated with the electronic sales transaction, the session metrics including information associated with operations performed by the two or more of the plurality of stages; and
presenting, by the server device, the session metrics associated with the electronic sales transaction.

9. A server device comprising:
a memory to store a plurality of design elements associated with a workflow design that, when deployed to a network associated with the server device, creates a workflow that permits a plurality of operations to be performed via an electronic transaction with a user device, where the plurality of design elements:
correspond to a plurality of stages that perform the plurality of operations associated with the electronic transaction or to one or more logical paths that interconnect the plurality of stages, and
permit design changes to be made to at least one stage, of the plurality of stages, that does not interrupt operation of the workflow; and a processor to:
receive a request to deploy the workflow design to the network,
deploy, to the network and in response to the request, the plurality of design elements to create the workflow,
receive a business object, associated with the electronic transaction, from an initiation stage of the plurality of stages, the business object including an indicator associated with initiation stage operations,
retrieve, from the memory, a workflow rule associated with a logical path, of the one or more logical paths, that interconnects the initiation stage to another stage of the plurality of stages, the workflow rule including a condition that, when satisfied, permits the electronic transaction to be transferred to the other stage, and
transfer the electronic transaction to the other stage based on a determination that the indicator satisfies the condition, where the other stage performs one or more operations, of the plurality of operations, via the electronic transaction with the user device.

10. The server device of claim 9, where one or more of the plurality of design elements, when deployed to the network, create one of the plurality of stages that is used to terminate the electronic transaction.

11. The server device of claim 9, where, when deploying the plurality of design elements to create the workflow, the processor is to:
store, in the memory, a workflow rule for each logical path of the one or more logical paths, the workflow rule permitting the electronic transaction to be transferred between two or more stages, of the plurality of stages, in order to complete the electronic transaction.

12. The server device of claim 9, where the processor is further to:
present, via a workflow user interface (UI) generated by the server device, the plurality of design elements to enable a workflow designer to create the workflow design.

13. The server device of claim 9, where each stage, of the plurality of stages, includes a business application, where the business application:
includes business logic to perform operations associated with the each stage of the plurality of stages, and
the business logic is separate from the workflow logic.

14. The server device of claim 9, where the processor is further to:
receive another business object, from the other stage, that includes information indicating whether a particular operation, of one or more operations associated with the other stage, has been performed,
retrieve, from the memory, workflow rules associated with the other stage, the workflow rules indicating that the particular operation is to be performed as a condition to transfer the electronic transaction to a further stage of the plurality of stages, and
transfer the electronic sales transaction to the further stage when the other business object indicates that the particular operation has been performed.

15. The server device of claim 9, where the other stage is a projected stage, of the plurality of stages, to which the electronic transaction is transferred:
only via one or more predecessor stages, and
when the condition is satisfied, and where the initiation stage is one of the one or more predecessor stages.

16. The server device of claim 15, where the processor is further to:
receive a state object, associated with the electronic transaction, from the initiation stage that includes an identifier associated with the initiation stage,
determine the logical path that interconnects the initiation stage to the other stage, the logical path including the condition and information that indicates that the other stage is the protected stage.

17. The server device of claim 9, where the processor is further to:
receive another request to view workflow metrics for one or more electronic transactions performed during a particular period of time,
retrieve, from the memory and in response to the other request, session metrics for each one of the one or more electronic transactions performed during the particular period of time, the session metrics for the each one of the one or more electronic transactions including information regarding operations performed by one or more of the plurality of stages,
process the retrieved session metrics for the each one of the one or more electronic sales transactions to obtain a quantity of electronic transactions performed during the particular period of time, and
present, on a display associated with the server device, the quantity of electronic transactions.

18. A system comprising:
a storage device to store a plurality of design elements associated with a workflow design that, when deployed to a network associated with a server device, creates a workflow that permits a plurality of operations to be performed via an electronic transaction with a user device, where
the plurality of design elements correspond to a plurality of stages that perform the plurality of operations associated with the electronic transaction or to workflow logic that establishes conditions to transfer the electronic transaction between one or more stages of the plurality of stages associated with the workflow, and
each stage, of the plurality of stages, includes business logic to perform at least one operation, of the plurality of operations, the business logic being separated from the workflow logic that permits design changes to be made to at least one stage, of the plurality of stages, in a manner that does not interrupt functionality of the workflow; and a server device to:
receive a request to deploy the workflow design to the network,
deploy, to the network and in response to the request, the plurality of design elements to create the workflow, and
conduct the electronic transaction with the user device by transferring the electronic transaction between an initiation stage, of the plurality of stages, and at least one other stage of the plurality of stages, based on the workflow logic associated with the initiation stage and a business object that includes information associated with an operation, of the plurality of operations, performed by the initiation stage.

19. The system of claim 18, where one or more of the plurality of design elements, when deployed to the network, creates at least one intermediate stage, of the plurality of stages, that is used to perform one or more of the plurality of operations associated with the electronic transaction.

20. The system of claim 18, where one or more of the plurality of design elements, when deployed to the network, creates at least one of:
a protected stage that is to be entered from a particular stage, of the plurality of stages, that is identified in workflow rules associated with the protected stage and when a condition associated with entering the protected stage is satisfied,
an automatic transfer stage that permits the electronic transaction to be automatically transferred to another stage, of the plurality of stages, based on business logic associated with the automatic transfer stage, or
a user interface (UI)-less stage that does not include a UI via which information, associated with the UI-less stage, is presented to or received from the user device.

21. The system of claim 18, where the server device is further to:
present, via a workflow user interface (UI) generated by the server device, the plurality of design elements to a workflow designer to permit the workflow designer to at least one of create the workflow design, deploy the workflow design to the network, or view workflow metrics associated with the electronic transaction.

22. The system of claim 18, where, when conducting the electronic transaction with the user device, the server device is to:
receive a state object from an intermediate stage, of the plurality of stages, the state object including an identifier associated with a the intermediate stage of the plurality of stages,
retrieve, from the storage device, workflow logic associated with the intermediate stage,
determine that the next stage, of the plurality of stages, is not a protected stage, and
transfer the electronic transaction to the next stage based on the determination that the next stage is not a protected stage.

23. The system of claim 18, where, when conducting the electronic transaction with the user device, the server device is further to:
receive another business object from the at least one other stage of the plurality of stages, the business object including an indicator that particular information associated with the user device was received,
retrieve, from the storage device, workflow logic, associated with the at least one other stage, that indicates that information associated with the user device is to be received as a condition to transfer the electronic transaction to another stage of the plurality of stages, and
transfer the electronic transaction to the other stage to process the information associated with the user device based on a determination that the particular information associated with the user device satisfies the condition that the information associated with the user device is to be received in order to transfer the electronic transaction to the other stage.

24. The system of claim 18, where the server device is further to:
receive a request to edit the workflow design,
present, on a display associated with the server device, a workflow user interface (UI) that includes the plurality of design elements associated with the workflow design,
receive, via the workflow UI, design changes, to the workflow design, that include changes to business logic associated with the at least one stage, of the plurality of stages, and
deploy, to the network, the design changes in a manner that does not interrupt the functionality of the workflow.

25. The system of claim 18, where the server device is further to:
receive another request to view workflow metrics for one or more electronic transactions performed during a particular period of time,
retrieve, from the storage device and in response to the other request, session metrics for each one of the one or more electronic transactions performed during the particular period of time, the session metrics for the each one of the one or more electronic transactions including information regarding one or more of the plurality of operations performed by one or more of the plurality of stages,
process the retrieved session metrics for the each one of the one or more electronic transactions to determine an average total cost associated with the one or more electronic transactions performed during the particular period of time, and
present, on a display associated with the server device, the average total cost associated with the one or more electronic transactions.
